(19) United States
(12) Patent Application Publication
(10) Pub. No.: US 2025/0036487 A1
(43) Pub. Date: Jan. 30, 2025

(54) ARTIFICIAL INTELLIGENCE INFRASTRUCTURES WITH TOPOLOGY BUILDER AND CLIENT SIDE PERSONALIZED TRUSTED OUTPUT

(71) Applicant: Fantagic Holdings LLC, Naples, FL (US)

(72) Inventors: James Duane Bennett, Naples, FL (US); Bindu Rama Rao, Naples, FL (US)

(21) Appl. No.: 18/779,517

(22) Filed: Jul. 22, 2024

Related U.S. Application Data
(60) Provisional application No. 63/529,461, filed on Jul. 28, 2023.

(51) Int. Cl. G06F 9/54; G06F 21/10

(52) U.S. Cl. CPC G06F 9/54; G06F 21/10

(57) ABSTRACT

Host services in an artificial intelligence (AI) infrastructure supporting a visual creation interface of multi-node AI based topologies in segments and partitions to service various overall AI objectives across multiple host, creator, user and third party devices and systems. Training of AI nodes, testing, automatic topology assessment and adjustment is provided. Secure interaction between topology partitions supports privacy concerns. Influencers and celebrities provide personal data to AI topologies to automatically generate topology node configurations, training data and datasets that can be swapped into any topology for those addressing host's digital rights management compensation and restrictions. Host services provide platforms for sharing created AI topologies, AI generations based on such AI topologies, and celebrity and influencer elements thereof. User device circuitry bisection supports secure topology operations and communications with other topology partitions, and allows for compartmentalization of privacy concerns. AI generated output can be generally produced can be prepared post generation or output with such form which supports personalization through population with personal data elements and types. Drag and drop visually topology building is enhances with software interfacing through software development kit usage. Host services screens uploaded data to identify third party ownership issues and provides a service for gathering authorizations, allocating associated sharing, and applying digital rights restrictions.

### RELATED APPLICATIONS

The present application incorporates by reference herein in its entirety and for all purposes U.S. Provisional Applications: a) Ser. No. 63/525,817, filed Jul. 10, 2023, entitled “Multi-Node Influence Based Artificial Intelligence Topology” (EFS ID: 48272269; Atty. Docket No. GA01); and b) Ser. No. 63/528,145, filed Jul. 21, 2023, entitled “Segment Sequencing Artificial Intelligence Topology” (EFS ID: 48330922; Atty. Docket No. GA02).

### BACKGROUND

### 1. Technical Field

The present invention relates generally to generative and discriminative artificial intelligence; and, more particularly, to remote and local artificial intelligence serving a common functional objective.

### 2. Related Art

Basic training and deployment of single nodes of generative and discriminative Artificial Intelligence (hereinafter “AI”) is commonplace. Various AI models currently exist while other models are under development to gain high quality AI output and discrimination. In addition to the model's themselves, the amount of training data utilized continues to grow with quality of training data also becoming more important. Most AI models operate in the cloud due to: a) heightened processing, speed, and storage demands; b) massive numbers of user requests to service; and c) design goals of responding to user service requests that have little subject matter bounds. Because of these factors, users will inevitably end up being assessed costs associated with such cloud based AI services, e.g., in advertising or periodic charges to use such AI models.

Moreover, if the cloud AI service receives too many simultaneous requests beyond its capability or when a denial of service attack takes place, servicing user requests becomes unpredictable. Many users will find unacceptable delays or are guided to try again later. And when a user's device is offline, such cloud based AI services become fully unavailable.

Turning to the cloud based AI models themselves, they are designed and trained to operate as single node AI elements, for example, taking in user text queries and output anything such as a poem, short story, or summary description. This comprises only a fraction of what each user would like to accomplish in their particular overall goal underlying their desire to use the single node AI service. Users will seek out third party vendor AI solutions tailored to a user's particular needs, however untrustworthy vendors may use this opportunity to operate as malware seeking to influence users and extract user's most private data for nefarious purposes.

These and other limitations and deficiencies associated with the related art may be more fully appreciated by those skilled in the art after comparing such related art with various aspects of the present invention as set forth herein with reference to the figures.

### BRIEF SUMMARY OF THE INVENTION

The present invention is directed to apparatus and methods of operation that are further described in the following Brief Description of the Drawings, the Detailed Description of the Invention, and the claims. Other features and advantages of the present invention will become apparent from the following detailed description of the invention made with reference to the accompanying drawings.

### BRIEF DESCRIPTION OF THE DRAWINGS

FIG. 1 is a schematic and pictorial diagram illustrating exemplary systems and circuitry of a trusted artificial intelligence store offering AI topology construction support for vendors and client support with secure output personalization within client devices, in accordance with various aspects of the present invention;

FIG. 2 is a schematic and functional diagram illustrating exemplary operations carried out by processing and neural net circuitry 201 based on a sub-segment topology defined using either a topology builder or via a toolkit (i.e., a software development kit or SDK) by an AI vendor on behalf of one or more users;

FIG. 3 is a schematic block diagram illustrating exemplary bifurcated circuitry configured with multiple AI elements that generate population readied output having little or no access to a user's private data during such generation, wherein population of private data into the generated output is conducted within trusted private circuitry having access to a user's private data in accordance with various aspects of the present invention;

FIG. 4 is a schematic diagram illustrating a multiple tiered AI topology spanning across three systems, each system operating a sub-topology that has certified access to certain local system private data, and whatever further certified access is provided by other system's sub-topologies, wherein overall access to private data is managed by providing AI and support processing topologies at each tier with resulting output generated and shared masking much of the underlying private data, in accordance with yet other aspects of the present invention;

FIG. 5 is a schematic diagram illustrating an exemplary embodiment of a host and client side trusted configuration involving host side AI topologies that generate output readied for client side personalized population, wherein such generated output is trust certified and the host side having no access to client side personalizing data used for population, illustrating various aspects of the present invention;

FIG. 6 is a schematic block diagram illustrating exemplary interactions between a host side service infrastructure supporting AI topology creation conducted by any of a plurality of creators, i.e., third party vendors, wherein segmented and unsegmented topologies including sub-segment topologies involving multiple types of output are defined, tuned, trained and tested via a visual builder interface (Internet based and App based) or via a direct SDK definition, illustrating yet other aspects of the present invention;

FIG. 7 is a flow diagram illustrating yet other aspects of the present invention in an exemplary visual topology building progression to service an overall AI generation objective as carried out by a creator interfacing with a host service, including trust and digital rights management (DRM) attention and associated certifications;

FIG. 8 is a flow diagram illustrating AI element training based on host certified datasets, excerpts thereof, as well as creator (vendor) uploaded datasets that are subjected to ownership and authorization checks, associated with license fees collections and distribution, and carry access restrictions that extend to the overlying topologies, and wherein personal population readiness may or may not be trained in, in accordance with yet other aspects of the present invention;

FIG. 9 is a sub-segmented topology diagram illustrating one embodiment of a visual builder interface in accordance with the present invention, wherein using builder tools and dragging topology nodes into sub-segment frame space, a topology creator, defines a segment of a segmented overall topology specifications along with visual output formatting frameworks to serve a particular overall AI generation objective such as generating a child's storybook with paragraph text and a single image per page, in accordance with at least many aspects of the present invention;

FIG. 10 is topology diagram illustrating one embodiment of a partitioned topology architecture defined through a visual builder interface (or defined in whole or in part through the topology SDK and displayed visually) in accordance with various aspects of the present invention, wherein topology partitions define functionality to be carried out on a plurality of systems such that security, privacy and anonymity can be maintained and certified; and

FIG. 11 is a diagram illustrating an exemplary AI training topology designed in accordance with the present invention wherein a baseline or untrained AI node is trained by a hosting service utilizing both selected groups of training data from pre-prepared training datasets and also uploaded training datasets of a creator with ownership and authorization concerns curated and certified by the hosting service.

### DETAILED DESCRIPTION OF THE DRAWINGS

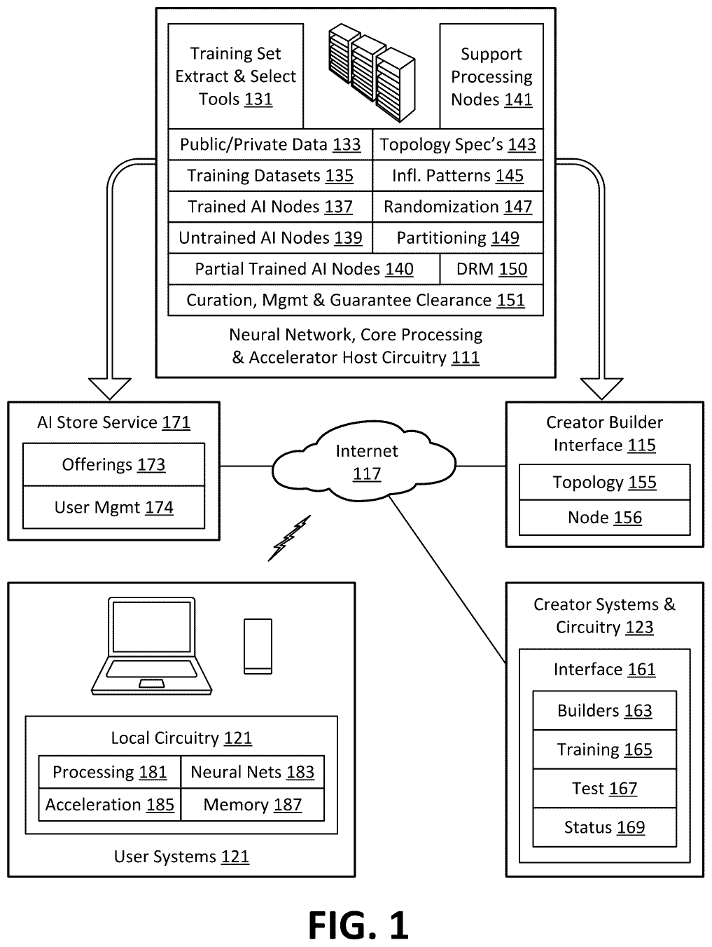

FIG. 1 is a schematic and pictorial diagram illustrating exemplary systems and circuitry of a trusted artificial intelligence store offering AI (Artificial Intelligence) topology construction support for vendors and client support with secure output personalization within client devices, in accordance with various aspects of the present invention. Host circuitry 111, provides, with DRM (digital rights management) support and searchable and browsable based selection interfacing, a hosting infrastructure that provides: 1) a generated content hosting service for distributing posted AI generated output; 2) a topology builder hosting service supporting creation of entire AI topologies that include, but are not limited to, sets of host's support processing, trained AI nodes, influence patterns, input interface, and output interface nodes that may be selected in a visual icon based drag, drop and configuration style topology building approach that also supports uploads from and integration with a host provided topology SDK (Software Development Kit); 3) a topology hosting service wherein created AI topologies can be offered for all or select users' own generation desires, with or without personalization support; and 4) a node modification and creation hosting service wherein any type of the hosts supplied topology nodes may be cloned and modified, trained or created from scratch entirely within a provided visual interface or via uploads or interactions via the SDK. Regarding the node modification and creation hosting service, this might include, but is not limited to creation of a modified support processing node by using manual or AI assisted programming modifications to a current host provide support processing node. It may also involve mergers of parts of two or more support processing nodes with or without AI assistance, and so on. Regarding AI nodes, a creator may choose from fully untrained, partially trained AI nodes provided by the host, and train or fine tune train them to achieve an alternate generative output objective. These and other nodes such as influence nodes, outside influence nodes, influence pattern nodes and output formatting nodes, to name a but a few, may be fully replaced or cloned and modified as well to achieve objectives not available from the host's provided node sets.

For all hosting services, rating and commentary support interfaces are provided. Guarantee owners, creators and users (or herein “clients”) an overall safe and trusted environment free from AI supported fraud and other malfeasance, the host circuitry 111 and supporting hosting services are designed employ data flow security, private data compartmentalization, and employ DRM practices along with adequate watermarking and distribution controls with host curation an validation of overall generative AI objectives. Further efforts are made to limit third party hidden malware introduction by monitoring, evaluating and controlling third party topology nodes introductions to detect malware attempts and to identify and prevent associated DRM issues. Curation being key on a node by node and overall topology basis to establish a hosting environment that can be trusted by users, owners, and creators.

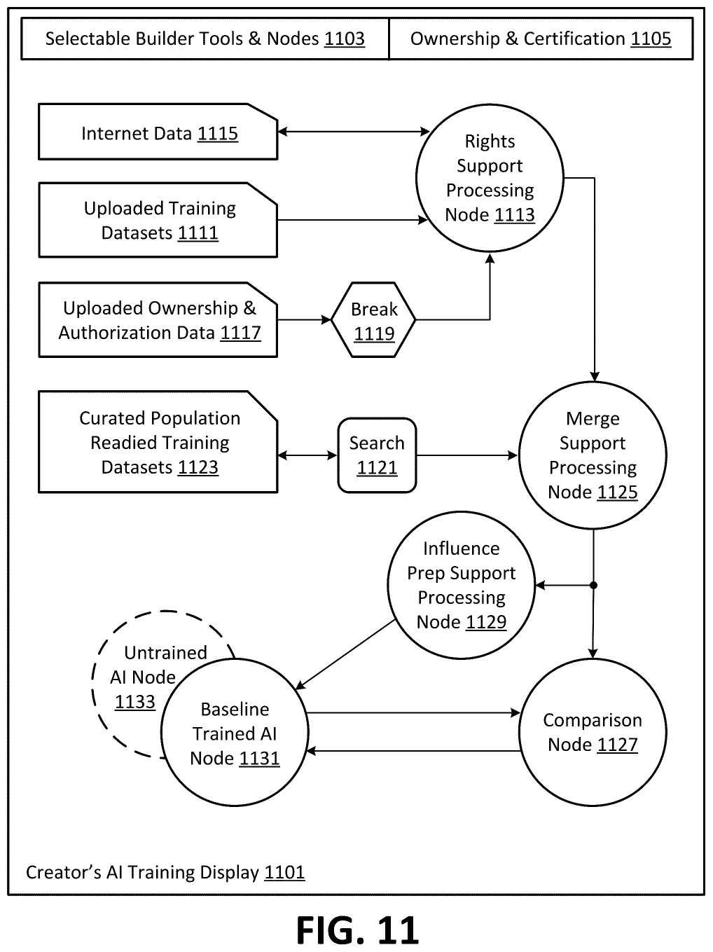

To carry this out, the host circuitry contains, for example, training set extraction and selection tools 131 used via a node builder 156 of the creator builder interface 115. Specific node builder interaction to support AI node training is described in detail with reference to FIG. 11. A host's predefined malware free set of support processing nodes, support processing nodes 141, provide a variety of pre and post processing that may be needed to prepare input or configure output of each of the host's provided AI nodes. The support processing nodes 141 include some that are configurable while others are designed to provide a fixed function.

Public and private data 133 provides for communication security as well as use for third party advertising in an anonymous manner, protecting users, creators and owners from non-curated advertising and other contact reach. For example, an advertiser may deliver a permitted search request along with a desired communication that may reach and group of users, owners or creators. A related hosting service supporting such request may control the format and curate the communication before allowing distribution as users, creators and owners may choose to opt in or out of such flows. Those that do not opt out receive the communication without the advertiser knowing their identity or having access to their contact information. Should particular users, creators or owners respond, the advertiser (or communication sender) can establish their own contact relationships which the responder may deliver via giving at least credential access via their private data within the public and private data 133.

The public and private data 133 is also used by certain topology nodes to help with topology generation goals as will be illustrated herein with reference to many of the other figures. Similarly, influence pattern nodes 145 are provided for topology building and provide data input that influences an associated AI output generation. Influence pattern data may be textual, image, video, audio, voice and based in any other type of data that an AI node expects as influence input for generating output. AI generations with population readied output and influence patterns 145 may also involve randomized or pseudo-random population the configurations of which being stored within randomization 147.

Such AI nodes available for inclusion in topologies are host provide, i.e., trained AI nodes 137. Via a training visual interface provided by the node builder 156, a creator may train a fully untrained or partially untrained AI node, i.e., untrained AI nodes 139 and partially trained AI nodes 140. Such training can be based on uploaded and curated training datasets or be based on or extracted from host's training datasets 135. Curation of training datasets, uploaded topology and topology node related elements and data, and overall topologies are subjected to curation, management and guarantee clearance functionality 151.

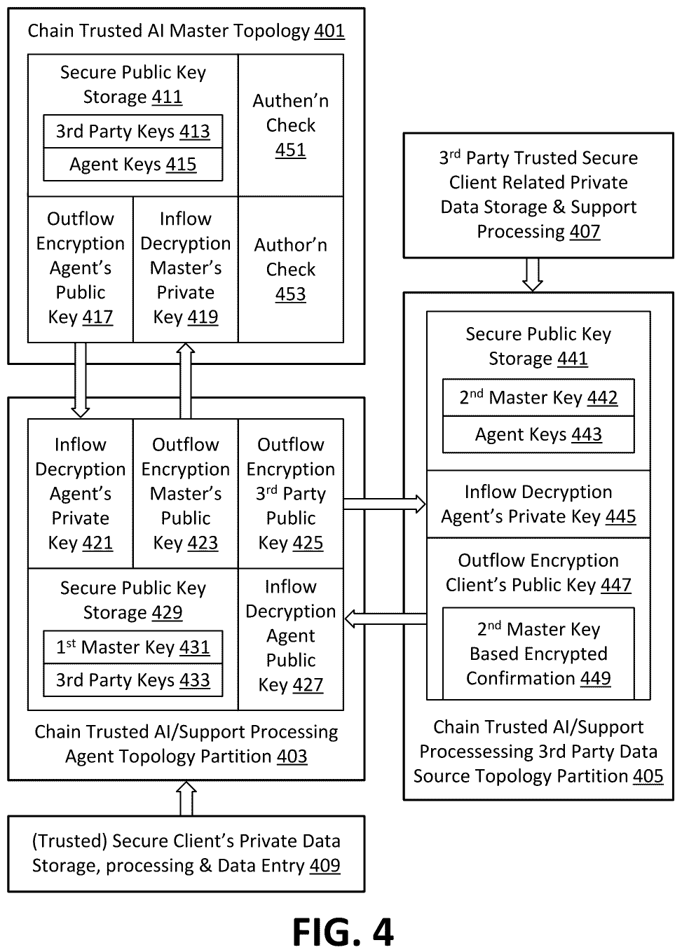

Topologies may be created with a serialized segment by segment approach, at least a somewhat parallelized segmented approach, or created with a single segment design. All approaches may utilize secure partitioning wherein activities on the host side, client (user) side and creator side systems and underlying circuitry are compartmentalized to both distribute processing needs and to help constrain access to private host, client and creator side data, algorithms and AI nodes and topology flow that would be revealed if not for the topology partitioning. For example, a creator may through interaction of the host, require that host provide no access to the creator's topology partition which will be used to service a client topology to which the client may have full access to see the inner workings. The creator may also through interactions with the host define that the client will have limited or no access to the detailed inner workings of the client topology partition. Similarly, a first user that operates a client topology partition via a first user's device may interact in accordance with the client topology partition with a plurality of other users that run copies of the client topology partition on their own devices. Such interactions, as defined by the creator, require secure data exchanges and private information exchange needs can be minimized by the client topology partition's underlying AI and support processing functionality. Chains and tree structures of topology partitioning across devices and systems to perform many needed overall AI generative objectives is also contemplated such as that described in reference to FIG. 4 below.

DRM (Digital Rights Management) 150 functionality involves providing an overall hosting framework in which collection and checking of ownership, authorization, usage rights and related payment collections and shared distributions at every step of node configuration, training and topology generation. At each step and for all creative contributions, rights are admixed with derivative rights included. This process and related curatorship provides a significant value proposition for all involved.

The host circuitry 111 consists cloud infrastructure including racks of neural network circuit elements, core processing elements and accelerators to assist in all of the host processing needs to carry out all of the functionality described herein. Such functionality including but not limited to an AI store service 171 where users interact to gain access to offerings 173 such as (i) AI topologies that they can operate to generate output on demand, and (ii) previously generated output in population readied and fixed format. Users may also interact to manage their accounts, set up secure linkages, and make payments via user management 174. The creator may for example interact via a creator builder interface 115 wherein topologies and topology nodes can be defined, configured, uploaded, trained, tested, configured and managed, e.g., via the topology builder interface 155 and node builder interface 156. These are just a few of the many interfaces contemplated (many of which are described herein with reference to the following figures) that may be offered to various parties involved by the host circuitry 111.

Although much of the secure communication flow involves Internet 117, intranets, cellular and satellite and any other communication means and infrastructures may replace or be add thereto. User systems 121 each comprising local circuitry 121 are configured with processing circuitry 181, neural net circuitry 183, acceleration circuitry 185 and memory from which topology partitions or topology nodes may be defined by an overall topology to provide required functionality to serve an overall AI generation objective. In addition, although not shown, user systems 121 may not only contain secure communication circuitry elements to guard from nefarious data interception and misuse, but may also contain secure portions of the local circuitry 121 such that even software running on the unsecure portion of the processing circuitry 181 cannot snoop or interfere with ongoing topology related operations or data storage related thereto. Moreover, output player related circuitry (and other output related circuitry) may be secured such that key based security can ensure that output from a topology only reaches output circuitry of any sort with an internal secure pathway. Again, this prevents any nefarious software running on the unsecure portion of the processing circuitry 181 from snooping, copying or modifying the topology generated output.

Similar secured portions of (and communication pathways between) processing, memory and output circuitry may be maintained within the underlying circuitry with creator systems, i.e., within creator systems and underlying circuitry 123. Creators may be engaged by vendors (or work as an employee thereof) to produce a vendor's AI topology based service via the host circuitry 111. Although this vendor topology service may be licensed by the host to run fully on the vendor's systems, vendors typically use or are restricted to use the host's hosting services provided by the host circuitry 111. As mentioned and described in detail herein, various interfaces 161 are supported including various builders 165, training 165, testing 167 and status 169.

The topology builder hosting service supports creation of entire AI topologies that include, several cloud based support processing nodes, a plurality AI models of similar capabilities but differing in quality, cost and availability, such that a creator building a topology using a creator tool can select one or more of the cloud based support processing nodes and corresponding AI models based on cost, based on needs of intended end users and based on several other factors.

The topology builder hosting service supports creation and storage of a topology using a drag and drop creator tool wherein a lightweight backup local node is automatically assigned to the topology for every significantly high performing node selected by a creator that runs on a host service, so that whenever such high performing nodes are unavailable or communicatively cut off from others during the execution of the flow of activity in guided by a selected topology, the lightweight backup local node is automatically incorporated so as to complete any processing or generation activity successfully.

Representative icons, although not shown, can also be added that represent entire topology sub-portions to simplify visual design efforts in a nested approach wherein such represented icons can be interacted with to expand to reveal topology underpinnings. As with other topology node icons, representative nodes that can be placed in drag and drop fashion and when interacting a clear window allowing for another topology upload, selection, or buildout from scratch. For example, within such clear window, a representative icon's associated topology can be designed as a particular finance related node, named and stored away for reuse. Thereafter, a creator may select such representative for any topology they may later build for any particular generative objective without having to redo the representative icon's corresponding topology each time. Specific examples of representative nodes might be a financial transaction client representative node with a topology that handles a specific type of client transaction needs. Another might be a credit worthiness representative node that operates on a client system and gains access to client data with secure topology partitioning. Yet another might comprise additional 3rd party financial historical record management nodes with topologies that anonymize an output summarizing a financial status of a user. In all such cases, the underlying topologies may include a few or a vast number of underlying topology nodes needed. Also, by placing topology behind such a representative node, a creator can interact to lock the node from prying eyes to further enhance security even after deployment.

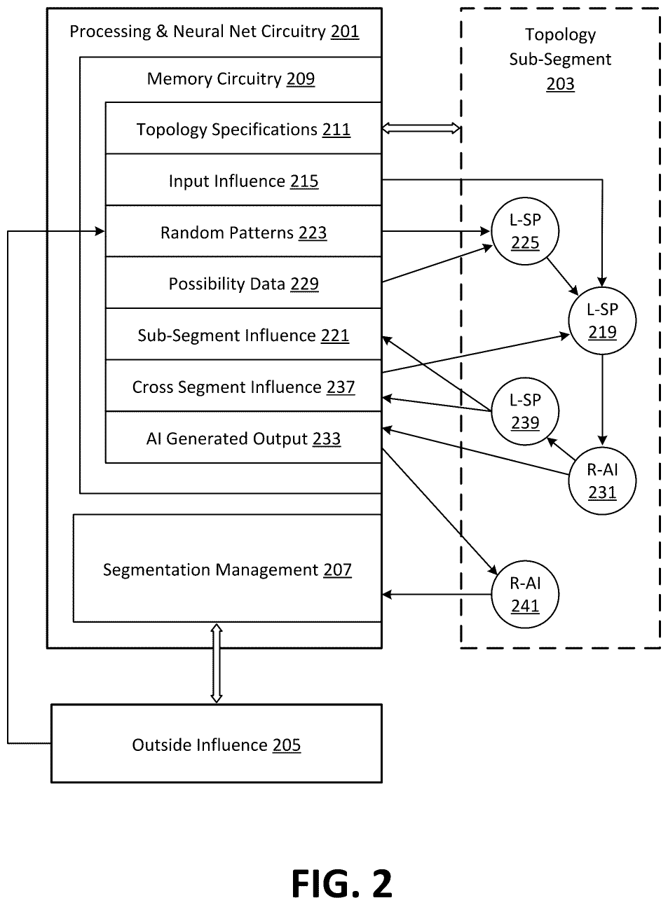

FIG. 2 is a schematic and functional diagram illustrating exemplary operations carried out by processing and neural net circuitry 201 based on a sub-segment topology defined using either a topology builder or via a toolkit (i.e., a software development kit or SDK) by an AI vendor on behalf of one or more users. Therein, processing and neural net circuitry 201, which may be any one or more of hosting, client (user), third party or creator system circuitry, accesses associated memory circuitry 209 to carry out operations of a single topology sub-segment. Such sub-segment may serve a single segment overall generative objective along with one or more other sub-segments, or may repeatedly serve a plurality of segments in a sequential flow of segments along with any number of other sub-segments contributing as well. Further, the topology sub-segment 203 may comprise elements and associated circuitry spread across one or many of the host, client, third party and creator systems and underlying circuitry. If fully contained within a single of such systems, it is considered herein as a topology partition.

In particular, the processing and neural net circuitry 201 when triggered to do so, will extract a selected topology specification from the memory circuitry 209, i.e., from topology specifications 211. Specifications stored within the topology specifications 211 being created with builder interaction from a host's visual topology building service. Because the selected topology specification defines a sequential flow of for example two sub-segments, the processing and neural net circuitry 201 begins with the first topology sub-segment, topology sub-segment 203. Therein, a local support processing node 225 first retrieves pattern text based selection of random influence patterns 223 and populates randomization bracketed text tagged entries from possibility data 229. For example, a text pattern might correspond to text “generate a storybook about a <profession: dentist>” wherein dentist is the default but may be filled by possibility data wherein the entry “profession” lists a long sequence of professions that might be interesting to a child. The professions list might also include personal data such as the father's and mother's professions along with other family member professions only. This random filling or swap out is referred to herein as one form of “population”, an unpopulated pattern is referred to as a “population readied pattern” (in addition to a “random pattern”), and a pattern with elements that have been filled is referred to as a populated pattern. As an aside, population and randomizing also applies beyond text to all other data types. For example, image based patterns may be populated with possibility lists of images. For example, a small image might convey image style, general ratio information, color palette and so on. From that small influence image via the random pattern's population inclusion, a trained generative AI may be influenced to produce a high resolution realistic image based thereon.

Consider a storybook generation objective configuration with a segment corresponding to a single page of an electronic storybook with a paragraph of story text and an associated image being generated for each page. To carry this out, the processing and neural net circuitry 201 begins by performing a certain pre-defined configuration of the topology sub-segment 203 that generates a sub-segment based paragraph of text for a single segment (page). Therein, the populated influence pattern text produced by the local support processing node 225 (mentioned above) is delivered to local support processing node 219 for a balanced merger with influence from input influence 215 (such as user input text) and cross-segment influence 221 (i.e., inter segment influence from for example a text generation of a previous segment needing to influence the current segment generation to maintain context across segments). From this merger which may prioritize one source of influence over others, the local support processing node 219 delivers combined influence data to remote AI node 231 to influence the generation of the text paragraph to be applied to a current segment (page) of storybook text. Note that after the text paragraph generation, the paragraph is processed into a reduced influence format (e.g., removing words of lesser importance, stemming, etc.) and delivered for transfer via sub-segment influence 221 storage to influence a second sub-segment generation of a related image. Such influence is also delivered for transfer via cross-segment influence 221 storage to influence one or more following segment generations of subsequent page paragraph text, to influence storyline context and fluidity. AI generated output 233 storage is used to accumulate sub-segment and segment generations that combine to serve an overall segmented AI generation objective, such as the electronic storybook. Output organization support processing may then gather such generations and present them in a visual form, for example, that a child might expect for an electronic storybook.

In addition, a remote AI node 241 retrieves different AI generated output and makes comparisons. Correlation too low and even too highly correlating results may trigger a segmentation manager 207 software code carried out by the processing and neural net circuitry 201 to discard one or more, or even all generated outputs and forcing reruns with or without topology adjustments in a cyclic manner till a satisfactory correlation balance is reached.

The segmentation management 207 functionality includes the step by step carrying out the steps defined by the specified (sub) topologies. It also responds to outside influence 205 which may trigger an enhancement, alteration or replacement of topology nodes, topology portions, or entire overall topologies. Outside influence 205 might also trigger reruns, introduce topology breaks or pauses, or trigger further topologies to launch and operate in coordinated parallel and/or assign higher or lower common nodal resource and processing priorities.

Sources for the outside influence 205 might include, but is not limited to, input circuitry, output circuitry, communication circuitry, independent software applications, other topology operations, remote systems, system status, and so on. Most nodes may operate both locally or remotely but a creator of a topology may designate one over another to accomplish a goal. Some creator's topology will allow options for each node's location with priorities given. As circumstances change, e.g., loading and availability issues, choosing from the options will allow operations to take place or continue. Remote and local terms as used herein are relative term from the perspective of a client system or device. For example, the remote AI node 231 corresponds, for example, to a hosted AI node perhaps in a cloud arrangement, while the local support processing 219 is carried out in circuitry found within a client's phone or laptop, for example. Communication between a local and remote nodes such as between these two nodes flow through a secure communication linkage described in more detail with reference to FIG. 4 below.

In addition, in different configurations AI generated output described herein, such as that of the AI generated output 233, can be used not merely to drive a human targeted presentation. It can also or instead be used to drive functionality within a user device such as a phone, laptop and even a robotic device of the user. In fact, at least a portion the processing and neural net circuitry 201 may be found within such user device such as a robot. Some portions may support production of a robot voice, involve outside influence in the form of a robot located microphone and camera elements and other sensory measuring elements such as thermometers, barometers, GPS (Global Positioning System) data, time and date, and so on, as well as any number of output circuitry related elements within a robotic user device.

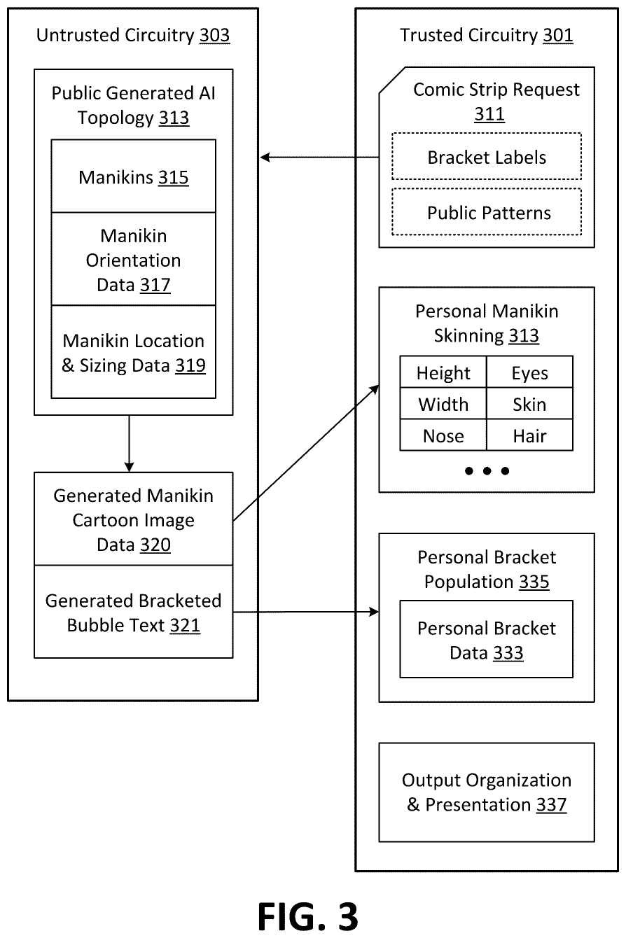

FIG. 3 is a schematic block diagram illustrating exemplary bifurcated circuitry configured with multiple AI elements that generate population readied output having little or no access to a user's private data during such generation, wherein population of private data into the generated output is conducted within trusted private circuitry having access to a user's private data in accordance with various aspects of the present invention. Therein, untrusted circuitry 303 operates using a first topology partition wherein public data is used by generative AI to create population readied output that may be filled or shared by any number of trusted circuitry 301. For example, a hosting untrusted third party might carry out generation of some desired output that can be downloaded and presented on any number of users' devices. Such a generated output built using public data may be sufficient for many of the underlying users, but others may desire personalization. Instead of delivering personal data to the untrusted circuitry 303 or to even trusted counterparts, some users would rather carry out personalization themselves in the privacy of their own devices or within fully trusted systems that they feel comfortable using.

To carry this out, either the generated output that fixed and not population readied must be post processed after the generation and after the receipt by a user device. To do this, the generated output may be subjected to algorithmic or AI based topologies which attempt to identify and tag elements of the generated output suitable for substitution or other personalization processing. For example, formal names in generated text might be identified and tagged such as every time a generated on public data novel's text mentions a man's name, that name might be replaced from a list of possibilities produced generated locally from family names. Thus, in a search and replace type approach, a family member could become a star of the novel. Other personalization readiness of finalized text may become more difficult. Personalization might attempt general appearance bracketing, but to replace wordy descriptive text may best be served with generative AI.

In addition, other generated output types beyond text may be even more difficult to make population readied. Further generative AI may for example be needed to recognize skin, hair, facial features and so on to ready it for local population based on a user's explicit or implicit (from personal data) preferences. The same difficulties apply to video in a similar image by image frame treatment. Audio population readiness may be optimal if the voice data used to make the original public generation can be transformed easily by local generative AI into forms that sound like the user, user's family or even celebrity's should the user have authorized rights therein.

Of course, a hosting untrusted third party may provide such post generation processed population readiness, or else the user may be made responsible along with the user's own population processing (or on behalf of the user by another trusted service). As illustrated, an untrusted third party via untrusted circuitry 303 generates an output that is population readied, and that output can be shared by any user downloading it to their device. Even though it is population readied, it can still be presented with default content by merely removing the population readiness. Also though, any user via their device and local private data can populate the downloaded generated content and present such content in a personalized way that may best please each user. Moreover, one user by generate an output that they find to be of high quality and choose to share that with other users. Such sharing may be shared as personalized or shared in the population readied state where other users can complete their own population and enjoy the shared content.

Specifically, untrusted circuitry 303, in the present exemplary embodiment, utilizes an AI based topology, AI topology 313, to generate population readied output. In this configuration, a generative AI element is trained with population readied training data such that output generations include population readied portions when used. For the text readiness, bubble caption text includes bracket labels 31 such as a generated bubble text “<dog-name: Spot> needs a belly rub” contains a population readied tag dog-name and has a prefilled generic option “Spot.” For example, if a user does not have a tag entry in their text tag database for dog-name, a population process will end up placing “Spot needs a belly rub” in the bubble. Alternatively, if based on access to the user's personal data, a user's current dog named “Biff” is found, then the text tag database may then be populated with a database entry dog-name: Biff. Thusly, a personal population for such user would end up with bubble text “Biff needs a belly rub.”

To carry this out, upon receiving generated bracketed bubble text 321 (one approach to population readiness) personal bracket population 335 using personal bracket data 333, extracted from a bracket database is used to swap out <dog-name: Spot> with “Biff.” In addition, if there are multiple possibilities for dog names, such as when there are several dog names indicated in one user's private data, there may be several names such as Biff, Rover and Sam that the user has personal ties to and that are added as possibilities from which one dog-name may be randomly chosen.

In addition, one example of population readiness can be prepared for each of the comic images. The comic generating AI and associated portion of the AI topology 313 prepares generated output in a population readied form for use by an output organization and presentation functionality 337. One approach is to create coloration swap out items. For example, skin color might be a certain color of brown, eye color a certain color of yellow, hair color a certain color of orange in the image generation with no other comic image elements using the same colors for other things like shoes and so on. Then, upon knowing this coloration scheme, a population support processing function may merely search and replace the known “readiness” brown, yellow and orange colors to those of the skin, eye and hair colors of a child that will read the storybook. Such a simple population might suffice for simple cartoon images and for related cartoon video production.

Another more complicated approach, one of many contemplated, involves the use of a manikin place holder, i.e., manikins 315. For example, if producing a 3D (three dimensional) animated cartoon, the manikins 315 can be trained into an image frame by frame generating AI such that the 3D content needed to place such manikins into any 3D position is contained as part of the orientation data 317. For sizing, manikin location and sizing data 319 may also be provided. In other words, on a frame by frame basis, manikin information is supplied but not added to layers of generated image data. Such layers allow for population by a user device of their own manikins into a generated frame. A far background generated layer is placed first, then a mix of different manikins (from a user's local private storage) and interleaving video layers and any needed overlayers. In this way, a user's personal manikins can be added into an overall video presentation. In this configuration, the entire manikin may be automatically generated from a 3D scan of a user (e.g., a child) translated to a comic style. Therein the entire personal manikin is placed in population processing in each layered video frame with appropriate location, orientation and desired expression provided therein. Alternatively, only parts of the manikin is substituted in by the population processing. Here, as shown, the personal manikin skinning 313 provides such an approach. Here various personal characteristics of the user (child) are added to a wire framed manikin that is generated without such features in the right orientation, sizing and position to accept the “skinning” type population approach. Such manikin skinning population can be applied as mentioned to video but also or alternatively to the comic strip 2D (two dimensional) images as a comic strip objective requires.

Here, the process begins with a comic strip request 311 wherein a user can define which of all the elements of a comic strip (or video or text) that they would like to have readied in the output generation. With this in mind, only select use of manikins and any other items that may be personalized need be applied in the generation. For example, a protagonist only population readiness may merely add the child (user) as the hero of the comic strip or video. The antagonist would then be populated with a public data influenced bad guy character generation. Adding further to the comic strip request 311 the desire for antagonist population readiness as well, would end up swapping out the hero and the bad guy with two manikins ready for population skinning by a user's system circuitry.

Also, population readiness may span beyond what is used for a human experience presentation. Population readiness may allow for tailoring to outside influence, i.e., input circuitry, output circuitry, control circuitry and so on, specific to the user's system such as a phone, laptop, home networking equipment, appliance, robot, alarm system and virtually any of a user's home electrics enabled device. Such population may then allow AI topologies to be self-tailoring to a user's systems and home environment without requiring that a creator of the topology anticipate all users' home electronics configurations.

FIG. 4 is a schematic diagram illustrating a multiple tiered AI topology spanning across three systems, each system operating a sub-topology that has certified access to certain local system private data, and whatever further certified access is provided by other system's sub-topologies, wherein overall access to private data is managed by providing AI and support processing topologies at each tier with resulting output generated and shared masking much of the underlying private data, in accordance with yet other aspects of the present invention. Therein, a particular configuration is illustrated in a tree structure wherein one master topology partition 401 interacts with a plurality of agent topology partitions such as agent topology partition 403. In turn, each of the plurality of agent topology partitions interact with pluralities of third party partitions, such as the third party partition 405. Of course, many other configurations such as where third party partitions directly communicate with the master partition, but this chained flow illustrated provides for minimizing the need for the master partition except when necessary and only by the agent partition if that.

Specifically, the master topology partition 401, agent topology partition 403 (in many cases the agent being a client or user depending on the particular overall generative objective sought), and the third party topology partition 405 communicate in secure ways using encryption and decryption schemes involving private and public key usage. Other approaches including using one time use keys, one time programmable memory (e.g., EPROM or electronically programmable read only memory) and secured hardware elements within a master system, agent system and third party system are contemplated.

As illustrated, public keys are securely exchanged between the master system operating the master topology partition 401 and the agent system operating the agent topology partition 403. Although possible at other times, this is done as part of the download process by the agent system interacting with the master system. A similar public key secure exchange is created between the third party systems and the agent systems.

The third party topology partition 405 is associated with private third party data and processing 407. Similarly, the agent topology partition 403 is associated with private agent data, processing and data entry 409. With these secure linkages public keys can be used for encryption and private keys for decryption of all communication flow. In particular, the master topology partition 401 utilizes secure public key storage 411 having public third party keys 413 and agent keys 415. Each agent system carrying out the agent topology partition 401 similarly uses secure public key storage 429 having public a first master key 431 and a series of third party keys 433. Each third party system carrying out the third party partition 405 also includes a secure public key storage 441 with public second master key 442 and a plurality of agent keys 443. Outflow encryptions 417, 423, 425 and 447 are carried out using public keys. Inflow decryptions 419, 421, 427 and 445 are carried out using private keys.

With this configuration, the overall AI topology can accomplish its overall objectives through secure partition delegation and gain a side benefit of minimizing exposure to private information of the master, agent or third party to any of the others or provide opportunities to bad actors. In this case, the overall AI generative objectives may require three different tiers of algorithmic processing and/or AI generation with each tier requiring access to one or more of the master, agent and third party data. Assuming partitions can be appropriately, as in the present example, the master topology partition 401 can be nearly completely isolated from needing access to the agent's and the third party's private data. In addition, the underlying operations of the master topology 410 may also be restricted from access by the agent and the third party. Similarly, by moving appropriate functionality into the agent topology (e.g., that which needs access to the agent's private data), access by the master and third party to such agent's private data can be substantially minimized if not fully restricted. And, of course, the same approach can restrict the master and agent from being able to access the third party's private data access via an appropriately designed third party topology partition 405. A bonus of minimizing the need to exchange personal data across the secure communication links further hardens the overall security of the overall topology flow and still accomplishes the overall objective.

In one configuration, the illustrated topology partitioning involves an overall AI objective of allowing a potential borrower find out whether their current financial situation is likely to support a lending relationship with a lender without even making an approach to such lender, and wherein the lender can make preliminary decisions of approached without having to gain specific access to a potential borrower's financial information. Along with this, a third party, using their topology partition can minimize their need to share more than what is absolutely need by the potential borrower and service this with an automated as rather summary exchange.

In this configuration, any potential borrower merely downloads the agent topology partition 403 and triggers its operation. Such topology guides the user through collections of different locally stored financial information and information received directly from the potential borrower who also identifies the needed borrowing amount. As such data is retrieved, AI and/or algorithmic support processing within the agent topology partition 403 may interrupt the process due to the potential borrower not meeting a minimum threshold of credit worthiness for the requested borrowing amount. The agent topology partition 403 may instead merely decrease the overall amount feasible under best circumstances as each new piece of information from the potential borrower or the potential borrower's private files are entered into the agent topology partition 409. If the maximum borrowing amount is acceptable or if the borrowing amount requests still seems possible, the agent topology partition 403 will begin communicating with each of the third party topology partitions 405, one by one. A first third party might be a credit reporting agency who returns instead of a raw rating, a credit worthiness probability range that generative AI or algorithmic processing within the third party topology partition 405 generates which is tailored to the type of borrowing purpose. A potential borrower may have a history of missing payments for utilities and credit cards, but have a spotless mortgage payment history. A single rating assessment of credit worthiness for a home loan versus a credit card ceiling must be evaluated in a more complex manner, and an AI assessment is likely to prove optimal for this task. Thus, after proving authorization and authentication, the agent topology partition 403 includes load purpose information as part of the rating assessment request and receives a tailored assessment in return without having to access and deliver historical payment information and so on or present a user interface and so on. Just minimal flow only as needed and with secure communication linkage outside of internet browser confines.

This rating information is then added to the AI or algorithmic assessment of credit worthiness within the agent topology partition 403. Again, the borrowing amount possibility total might be decreased. If still acceptable, the user via the agent topology partition 403 then reaches out one after another to employer earning verification based third party topology partitions, internal revenue partitions and so on, until the agent topology partition 403 reaches a satisfaction point which automatically invites the potential borrower to reach to the master topology partition for a loan information calculation handled with minimal information flow from the agent topology partition 403, mostly the AI output generations and algorithmic production data which substantially conceal the potential borrower and third party data as it is not yet needed. Instead, based on generations and productions from below in the chain, the master topology partition 401 calculates a possible interest rate, years of repayment, down payment percentage required, monthly amount due and so on and all automatic via AI nodes within the master topology partition 401. In addition, although not necessary for all third party's a catch and forward data encryption using the 2^{nd} public master key can be delivered by a third party to the agent topology partition 403 for forwarding to the master topology partition should a contact in the end be made.

Such data might be a mere confirmation acknowledgement of participation in the process or indicate an exceptional circumstance such as a bankruptcy pending.

Finally, if the potential borrower finds the potential offer acceptable, the master invokes a final stage of approval verification where the master topology partition interacts with the potential borrower via the agent topology partition 403 to gather all the personal data used to advance the process along without personal data sharing but which now must be received by the master topology portion 401 for final reevaluation and loan confirmation.

In another configuration, a master topology partition 401 might be configured to support a country-wide university admissions guidance system. The agent topology partitions 403 might be distributed to each student, and the third party topology partitions 405 might be delivered to all high schools, and another topology with linkages directly to the master topology partition 401 might communicate with universities. Here, the master topology partition 401 gathers from all universities their current number of seats for each degree program they service. The master topology partition 401 might also be communicatively coupled with cross country job seeking databases, employment demand prediction databases, and so on. The master topology partition 401 then identifies important prerequisites and subject strengths that are needed to find in a student for each university pathway along with a compensation factor associated therewith.

A student's agent topology partition 403 might then utilize an AI based topology to help the student locate a major and a position at a particular university to which they find interest along with a competitiveness factor and rate a student's personal capacity to perform well in such educational and career pathway. All graduating students in the country use their agent topology partition 403 to gather and assess their high school and scholastic achievement datasets. This dataset and additional information extracted from the student are delivered to an AI node within the agent topology partition 403 which generates a fitting dataset in a standard format which is delivered to the master topology partition 403. With all graduating students fitting datasets received, the master topology partition 401 sorts and maps every student to every college admission seat across the country with fit indications. In addition, prior year desirability data is added in along with a country's needed professionals from college career pathways so as to provide any student with a framework to zero in on their career fit. This information will also provide indications that universities should decrease their seat offerings for some majors and increase it for others. Government regulation can enforce this. In addition, government regulation can demand higher pay for careers in lower demand and even more for lower demand requiring higher capability students.

Students through their agent topology partition 403 may each then receive the generated output of the master topology partition 401 wherein they can peruse and look at best fit opportunities. Most student have no idea which path to choose. So instead of choosing every student in the country is ranked against all other students for every seat available at every university major. With this in mind, a student may then filter out all university seats that their rank does not fall within the designated number of seats. From such a remaining list, a student realizes that just by accepting any of the seats, they will instantly be accepted. In addition, the AI within the agent topology partition may take into account private information about the student such as their charismatic history, social skills, family characteristics such as location and so on and order the list in an advisory way. The student may add inject things they like such as managing people or working alone, and the underlying AI may readjust the ordering further. The underlying AI may also generate queries such as “would you be happy making twice the national average salary?” and so on. These queries then help influence the AI's ordering, and a student can ignore it or use the ordering to lodge their seat and complete the process. As this happens, they are instantly removed from all other seat lists and other students move up and may have their seat options expand. The process continues until the last student lodges their seat.

In this example, the master topology does not have to engage in developing student fit data. Nor do they ever receive private data regarding each student as extracted from their living history as gathered by the agent topology partition 403 to help make guidance and seat review ordering decisions. The agent topology partition 403 may also employ AI to generate based on all of the student's academic and personal data advice and answers to questions that the student may have such as “what would this career involve day to day?” Personalized answers tailored for that particular student like, “You may not like this career path as you seem very close to your family and will have to relocate to one of these cities” and so on. This partitioning allows for full use of a student's personal data without having to share it beyond the bounds of the student's personal device such as a phone. And with just generated fit data being delivered in a consistent manner to the master topology partition, the amount of interaction required with each student's agent topology and school systems can be minimized.

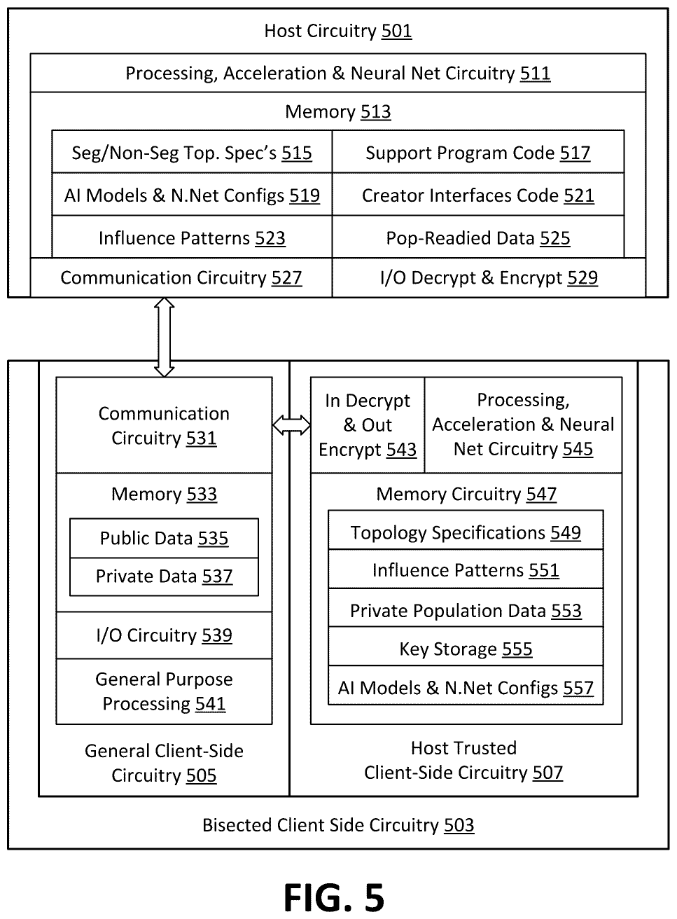

FIG. 5 is a schematic diagram illustrating an exemplary embodiment of a host and client side trusted configuration involving host side AI topologies that generate output readied for client side personalized population, wherein such generated output is trust certified and the host side having no access to client side personalizing data used for population, illustrating various aspects of the present invention. In general, host side circuitry 501 interacts with bisected client side circuitry 503 to carry out overall AI topology operations involving both the host circuitry 501 and host trusted client-side circuitry 507 along with assistance as needed with general client-side circuitry 505. Overall topology AI topology operations may include mixed local (client side and remote side topology nodes) or topology partitioning with host side topology partitions and client side topology partitions working independently and in secure cooperation to carry out an overall trusted AI generation objective.

Host circuitry 501 operates in much the same way and to carry out most if not all (depending on the configuration) of the functionality objectives described in relation to host circuitry described in relation to most of the other figures within this detailed description. As such, the host circuitry 501 contains, for example, processing, acceleration and neural net circuitry 511 that carries out host side AI topologies 515 which may be segmented, single segmented, partitioned and so on. The host circuitry 501 also supports creator interfaces to assist in building such topologies for operations on the host circuitry 501, on the client side circuitry 503, and on third party systems (not shown). To carry this out, stored within a memory 513, in addition to the AI topologies 515, support program code 517, AI models and neural network configurations 519, creator interfaces code 521, influence patterns 523, population readied data 525 (pattern based, training dataset based, and AI post processing created), communication circuitry 527 and input decryption output encryption 529.

Within the client side circuitry 503 (found within for example a user's robot, cell phone, laptop and so on) is bisected with a trusted client side circuitry 507 and a general client side circuitry 505 that cannot be fully trusted due to the execution thereon of third party software programs (i.e., Apps or Applications) which may contain malware. By bisecting the circuitry 503, the host circuitry 501 and the client can be reasonably confident that nefarious third parties via malware laden applications cannot penetrate the physical circuit barrier established by the bisection. Communication circuitry 531 supports typical communication exchanges that reach a general purpose processing 541 which may interact to access input and output circuitry 539, memory 533 and underlying public data 535 and private data 537 stored there. Thus there is a need for a user to be diligent with software application downloads that they may make to avoid malware infection, private data exposure and system malfunctions.

Communication flow between the host circuitry 501 providing a variety of AI topology related functionality with the client side circuitry 503 though key based encryption decryption flows (see key storage 555 and details with reference to FIG. 4 as but such key based example) wherein the general purpose processing 541 or any third party malware laden application cannot gain access to the underlying encrypted flow. Encrypted flow destined for the host trusted client-side circuitry 507 is decrypted using a private key associated with the host trusted client-side circuitry 507 and outgoing communication to the host circuitry 501 is encrypted before passing into the communication circuitry 531 which may be multiport or a shared in and outflow with appropriate priority allocated.

The host trusted client-side circuitry 507 includes an ability to perform partitioned or full topologies, segmented and single segment, and with subsegments if needed as defined by specific ones of topology specifications 549. All node related operations within topologies to be performed locally (within the host trusted client side circuitry 507) are supported by AI models and neural network configurations 557, influence patterns 551, private population data 553 (for unpopulated influence patterns and output population readied fillings) and support processing code, among other topology supporting elements identified throughout this specification. For some elements or portions of the topology specifications 549, the entirety of a client topology may be carried out by the general client-side circuitry 505 where, for example, private data 537 might be accessed or where less sensitive and private information within the host trusted client-side circuitry 507 or within the host circuitry 501 is not exposed or does not involve high risk even if malware is involved. In other words, at least the most sensitive operations of an overall topology is conducted between one or both of the host circuitry 501 and the host trusted client-side circuitry 507.

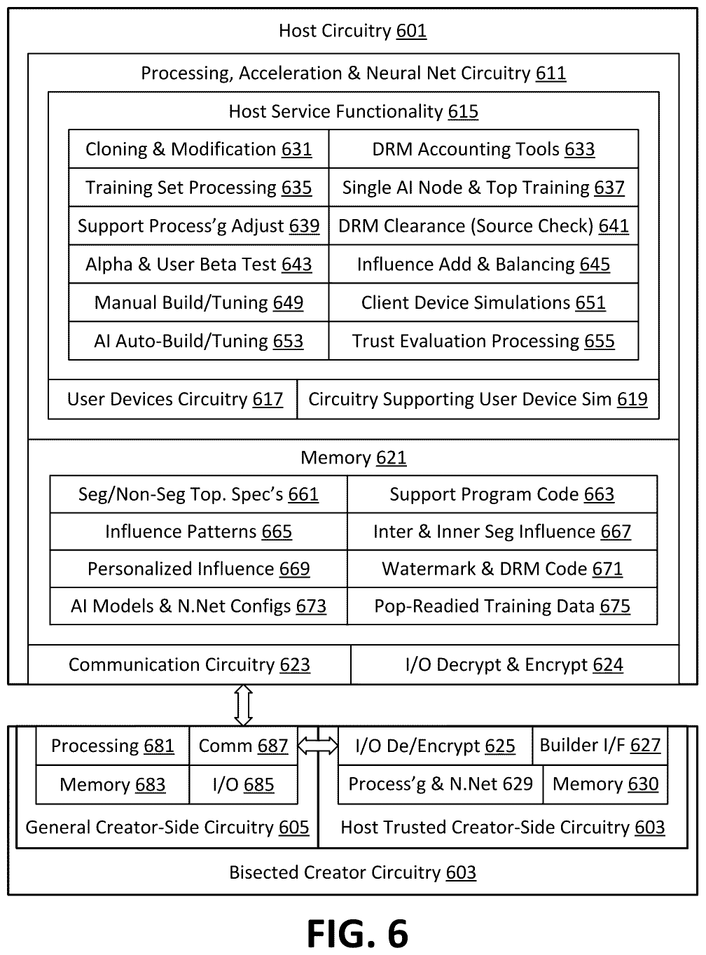

FIG. 6 is a schematic block diagram illustrating exemplary interactions between a host side service infrastructure supporting AI topology creation conducted by any of a plurality of creators, i.e., third party vendors, wherein segmented and unsegmented topologies including sub-segment topologies involving multiple types of output are defined, tuned, trained and tested via a visual builder interface (Internet based and App based) or via a direct SDK definition, illustrating yet other aspects of the present invention. As described with reference to FIG. 5 regarding the bisected client side circuitry, bisected creator side circuitry 503 also shares much of the same security advantages. The bisected creator side circuitry 503, within a creator devices such as a personal computers, laptops, smartphones and so on, includes general creator-side circuitry 605 and host trusted creator side circuitry 603. AI topology related activities, including but not limited to creation, testing and monitoring, at least when security is of concern is handled by the host trusted creator side circuitry 603. Other operations unrelated to AI topology are handled by the general creator side circuitry 605, which includes typical processing circuitry 681, memory 683, and input and output circuitry 685. A multiport communication interface 687 is also provided which supports the secure communication pathway between communication circuitry 623 of the host circuitry 601 and input decryption and output encryption circuitry 625 of the host trusted creator side circuitry 603. For communication flow unrelated to AI topology matters, the multiport communication interface 687 uses a first port communicatively coupled to the processing circuitry 681. For secure AI topology related matters, the multiport communication interface 687 utilizes a second port communicatively coupled via the input decryption and output encryption circuitry 625 with the processing and neural net circuitry 629.

For a variety of functional goals, the host circuitry 601, supports topology creators through interactions with the creators' systems that contain the bisected creator circuitry 503. For example, through builder interfaces 627, creators can upload (via software development kit interfacing) and visually lay out and configure AI based topologies from predefined topology node resources. Topologies include for example partitioned topologies, segmented topologies, sub-segmented topologies, mixed remote and local topologies, and combinations thereof. Where predefined topology node resources are insufficient for a creator's needs, the host provides tools to assist in defining and training additional nodes for inclusion, via visual interfacing and uploads. The host provides to the creator testing environments, including alpha and beta support with actual client interactions and monitoring. Simulated clients are also made available to assist creators with such testing needs. The host also provides a hosting service for creator topology advertising and download by clients for use. Such service may also include the host's active participation for carrying out topology node functionality which may extend to performing entire topology definitions to service a creator's overall AI generative objectives. Creators may also share trained and configured topology nodes, sub-topologies and even overall topologies with other creators, with DRM (Digital Rights Management) being enforced and carried out by the host.

New topology nodes may be created independently and uploaded or created using visual interfaces provided by the host, such nodes including but not limited to influence pattern nodes, outside influence nodes, support processing nodes, output formatting nodes, output nodes, input nodes, and also untrained, partially trained and fully-trained AI nodes, partially trained AI nodes, fully trained AI nodes which can be configured or further trained to serve other creator's derivative and training goals. A creator may also copy and creative derivatives of the copied node with DRM enforcement such as authorization for accessing details, use restrictions, and so on being enforced by the host. Such modifications and even new node creations are all supported with AI assist or can be defined fully or partially through manual creator entry. A new node may also be designed from bits and pieces of other nodes with underlying functionality elements desired by a creator, and entire nodes may be merged together, simplifying topology layouts.

For example, two interconnected nodes represented by two icons placed within a visual topology workspace can be visually merged into a single overall icon. Such visual merger may also be accompanied by true underlying mergers wherein AI guides the merger not only to combine, for example, program code into a single flow, but also to remove unnecessary code transformations that might be placed for interfacing as interfacing might otherwise be carried out directly in a merger. Similarly, merging different types of converging influence data might involve merging for example a search related node with an influence merging support node such that the original generation of search result influence balancing may be affected in the search influence creation process instead of waiting to readjust in a subsequent merging support node. Attempts to merge consecutive generative AI nodes might also be performed but this becomes more complex and requires selection or design of another AI node capable of providing a single substitute and then providing for a full retraining. Similarly, the creator may modify any node by splitting it into two or more nodes with or without AI assist.

In particular, through use of the bisected creator circuitry 503, a creator interacts to create, test, deploy, monitor and manage AI topologies through interfacing with the host circuitry 601. For security needs, the host trusted creator side circuitry 603 utilizes processing and neural network circuitry 629 to carry out processing support for such functionality. A memory 630 is also provided for storing needed program code, AI models, neural network configuration data, and all topology node related data and specifications. For non-topology related and where security is not an issue, processing circuitry 681 utilizing memory 683 interacts with input output circuitry 685. Some or parts of input and output circuitry 685 may be configured to support secure communication flow via the multiport communication interface 687 to the host trusted creator side circuitry 603.

Within the host circuitry 601, processing, acceleration and neural net circuitry 611, memory 621, communication circuitry 623 and input decrypt and output encrypt circuitry 624 can be found. As mentioned, the communication circuitry 623 and the input decrypt and output encrypt circuitry 624 interact to maintain secure communication flow with host trusted client side circuitry and the host trusted creator side circuitry 603 using key based security as described with reference to FIG. 4 below. Within the memory 621, a variety of storage is provided to assist in all hosting service operations. For example, some of these stored data types are illustrated, which include but are not limited to, topology specifications 661 (which includes all types of topologies such as segmented, single segment, partitioned, mixed, host only, sub-segmented and so on), influence patterns 665 (including random, population readied versions), personalized influence 669 (extracted via personal data search results), inner and inter segment influence 667 (flowing between topology sub-segments and segments), watermarking and other DRM enforcement and control program code 671, population readied training datasets 675 (from which creators may use extracts for training their custom AI nodes), and a variety of AI models and neural network configurations 673 (which underpin all of the host offered and creator's custom AI topology nodes). Such AI models and configurations 673 are carried by the processing, acceleration and neural net circuitry 611 during host side topology AI node operations. AI models being software AI models that employ central processing functionality that may also take advantage of acceleration circuitry to conduct AI node operations. In addition, some AI nodes may be defined to operate on neural network circuit elements such as analog or digital versions of neural network circuit arrays. Once trained, such neural network circuit array parameters are extracted, stored as configuration data and reloaded when necessary to carry out the neural network circuitry based AI node operations.

Within the processing, acceleration and neural net circuitry 611, host service functionality 615 can be found which may in whole or in part be assigned to dedicated circuitry or operate according to program code and AI design. In particular, The host service functionality 615 includes cloning and modification 631 of nodes and topologies that are permissible in view of underlying digital rights and carry forward DRM enforced usage limitations associated therewith. As creators interact to create topologies, DRM constraints of both others and those of the creators as well as those of the clients upon using the creator's topology is managed via tools interface 633.

Training set processing interface tools 635 are provided to support both AI node based training and topology segment training 637, which involve DRM clearance and source checking of uploaded training datasets. For example, for each dataset element, the host performs an Internet database check to identify whether a claim for originality by a creator is called into question. Also, authorizations a creator claims to have received by an owner is also checked by reaching out to the owner to verify such claims. Host tools also evaluate degrees of similarity using AI nodes trained to identify correlation percentages for all data types to try to avoid derivative work complaints. Creators may respond by eliminating certain problematic elements of their uploaded dataset. Once a creator is satisfactory under whatever DRM restrictions carry forward, training of an AI node proceeds using the host circuitry 601 operations. Thereafter, all DRM related restrictions of the training set and that which may accompany the AI node being trained are combined and carry forward to any topology that utilizes the newly trained AI node.

Testing support is also provided by the host circuitry 601. Client device circuit simulations 651 are also provided to provide a creator an opportunity to test functionality and stress test their created topologies and underlying newly created or modified nodes. Alpha and beta testing support 643 is also provided with usage logging, client sign up and acceptance, and performance and satisfaction response collections are gathered and presented to the creator such that they can assess everything from anticipated user demand to profitability and identify any further modifications that may be needed before final deployment. In addition, AI based tuning 653 may weigh in to troubleshoot and suggest changes. For example, some influence balancing adjustment recommendations might be made along with recommended replacements of certain nodes or changes to current node configurations and settings. Extra node additions might also be suggested. The AI based tuning adjustments being based on training from prior topology dataset information and trigger from recognized topology issues as well as client feedback. Finally, before deployment, trust assessment and evaluation processing 655 is revisited, wherein a creator can reconsider the implications of their own and others' ownership rights within their topology creations. Changes may be made to reduce such associated DRM obligations and assign billing related sharing arrangements which a creator and underlying owners have opportunities to accept or reject. Once this stage has completed, the host circuitry 601 may respond to a request to execute all or a portion of a creator's topology as certified and specified. For client and third party topology operations (operations with targeted topology partitions and full topologies) the host circuitry 601 posts those for download within an AI topology store.

A creator may designate any or all of their nodes and topology details as being private or may offer them up for cloning with carry forward DRM obligations. The host circuitry 601 and the trusted circuitry on each user and other creator device or system will then operate accordingly to ensure a creator's use and security designations be upheld.

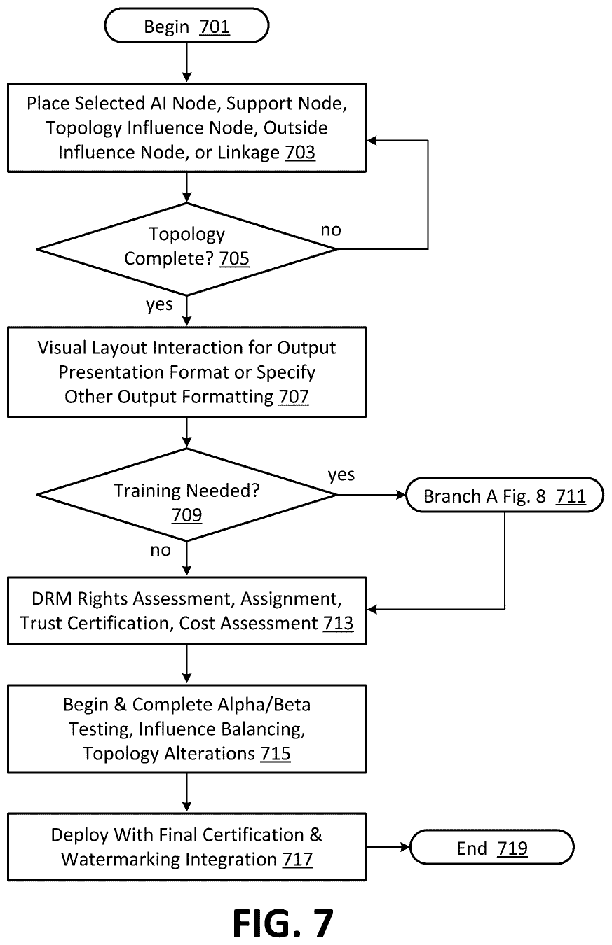

FIG. 7 is a flow diagram illustrating yet other aspects of the present invention in an exemplary visual topology building progression to service an overall AI generation objective as carried out by a creator interfacing with a host service, including trust and digital rights management (DRM) attention and associated certifications. Herein, via a host service's topology building interface, at block 703 and 705 in a looping fashion, a creator places all types of topology nodes, including but not limited to AI nodes, support nodes, influence nodes, outside influence nodes, link nodes and so on. Once the overall topology is complete, a visual layout interaction occurs at a block 707 where frames can be identified to constrain different generative output data types to correspond to an overall generative presentation objective.

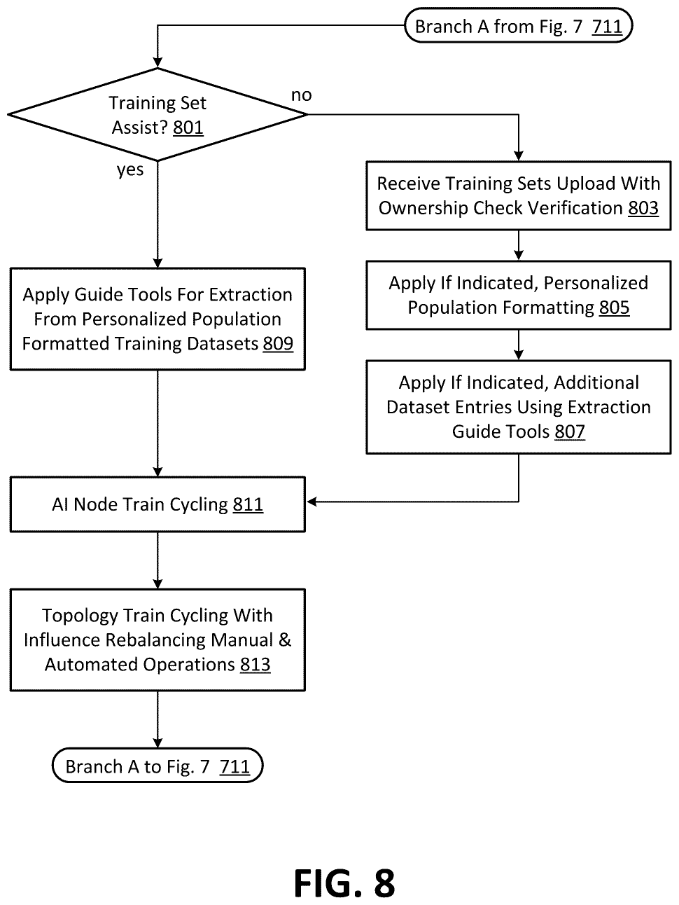

If any AI nodes need training, a branch A 711 to the process illustrated in FIG. 8 is exercised and, if so, once the training has completed, at a block 713 the trained node along with all associated ownership rights and authorization objectives are associated with the overall topology including all certifications related thereto. The topology itself is given other certifications by the host service including, for example, a client's private data exposure when a client exercises the creator's topology. At a block 715, the host service supports and monitors local, alpha and beta testing and provides authorizations needed to progress to full deployment with any required watermarking at a block 717 to reach the end of the process at block 719. Any alterations, influence adjustments and fine tune training (which may be single AI node fine tune training or training associated with an overall topology surrounding such AI node) found during pre-deployment or post deployment is also conducted at the block 715.

FIG. 8 is a flow diagram illustrating AI element training based on host certified datasets, excerpts thereof, as well as creator (vendor) uploaded datasets that are subjected to ownership and authorization checks, associated with license fees collections and distribution, and carry access restrictions that extend to the overlying topologies, and wherein personal population readiness may or may not be trained in, in accordance with yet other aspects of the present invention. Therein, when a need to train or fine tune train an AI node is identified in FIG. 8, a branch A 711 (FIG. 7 and FIG. 8) is exercised and, if training set assistance is needed as determined at a block 801, search tools and guiding support software assist a creator in extracting subsets of pre-certified training sets readied for population can be extracted for training dataset use at a block 809. If training set assistance is not needed, a creator's training dataset uploads are accepted but verification checks regarding ownership and with or without third party authorization is identified, checked and any associated DRM issues associated therewith. If population readiness is desired, support processing 805 operates to modify the uploaded training set to make it population ready as described herein. Extraction tools to add in pre-certified subsets of training data may be added in at a block 807 if needed.

After either the block 809 or the block 807, the host service completes training cycling of the AI node at a block 813. Such AI node 813 may be a purely software AI model with baseline or no training. It may also involve neural network analog or digital circuitry or a simulation thereof, and wherein each neural network elements resulting trained parameters are stored as a configuration to be applied whenever the topology calling for such AI node executes.

Lastly, full topology training cycling can be performed at a block 813 wherein influence rebalancing, added and dropped, and so on either automatically or with creator's manual adjustments until the creator is satisfied and branches back to the branch A 711 of FIG. 7 to complete the topology construction and deployment.

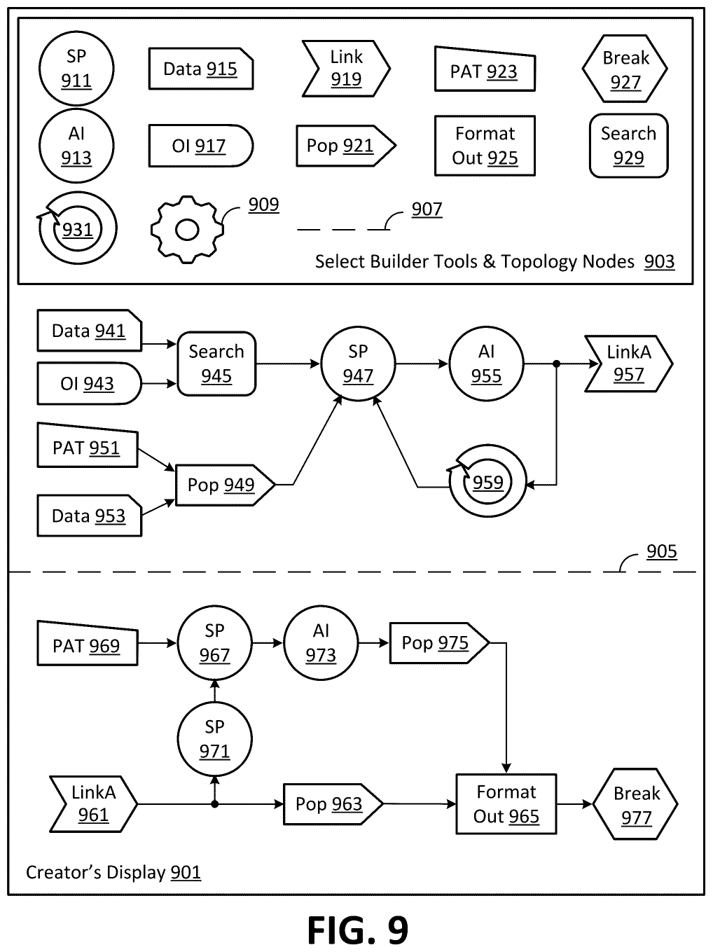

FIG. 9 is a sub-segmented topology diagram illustrating one embodiment of a visual builder interface in accordance with the present invention, wherein using builder tools and dragging topology nodes into sub-segment frame space, a topology creator, defines a segment of a segmented overall topology specifications along with visual output formatting frameworks to serve a particular overall AI generation objective such as generating a child's storybook with paragraph text and a single image per page, in accordance with at least many aspects of the present invention. Therein, a set of builder tools and topology nodes 903 are represented by various icons that may be dragged and dropped onto a workspace of a creator's display 901.

For example, a creator may select icons representing a support processing node 911, AI node 913, data node 915, output influence node 917, link node 919, population processing node 921, influence pattern node 923, output presentation formatting node 965, break node 917, search node 929, segment delay 931, setup tools 909 and a sub-segment divider 907. Once dropped on the workspace of the creator's display 901, creator interaction such as a right click mouse for example, allows for node type and configuration selections to tailor a select a node for a particular purpose. Hosted, client device or even creator system can be identified through such node interaction as the location of any node's operations so long as such location is capable of such operations. The sub-segment divider 907 once dropped in the present configuration places a sub-segment line such as a sub-segment line 905 where below that line a second sub-topology is dropped in and connected and above that line a first sub-topology is similarly dropped in and designed.

As illustrated, a creator drags and drops the icon of the data node 915 and drops it within the workspace of the first sub-segment, creating a data node 941 for the first sub-topology. Then by interacting with the data node 941, the creator can identify a local private memory file location where, for example, a collection of human generated storybooks are stored in digital form. The creator then drags an icon of the outside influence 917 and drops it to create an outside influence 917. By interacting with the outside influence 943, the creator selects user input text as the type of outside influence to be considered. The icon representing the search node 929 is dragged and dropped next, creating a search node 945 which responds to user input text from the outside influence 943 by using such user input text to search the data node 941, i.e., the collection of human generated storybooks. The search node 945 is also configurable on interaction to gather only portions of data related to the user input text along with other predefined factors such as genre identification, writing level, rhyme detection, age level and user rating information for such books. From this information, the search node 945 generates personalization influence (such as indicating subject matter, rhyme, genre and so on that is most likely to please a child reader). In addition to preprogrammed search configurations, a creator may upload their own approach via a software program code upload or creation within a separate window with manual entry by the creator or with generative AI coding assistance.

The creator then decides to add an influence pattern node 951 by drag and drop interaction with the icon representing the influence pattern node 923. Through interaction, the influence pattern node 951 can be tailored to define the framework needed by a storybook. For example, one preset choice might define a four lines of text, font style and size, and so on. As illustrated, the influence pattern node 923 also includes randomizing text, in this configuration bracketed text, that is to be filled from tree structured lists. For example, the influence pattern node 923 may include <main-character-name> which is to be filled by a population processing node 949 (based on a drag and drop from the icon representing the population processing node 921). To fill or herein “populate” the bracket <main-character-name> entry within the text of the influence pattern node 923, the population processing node 949 can be interacted with to identify a list or tree structure of possibilities that might appeal to a child. Such list might include family members' names and the child's name. It might also contain favorite cartoon characters, family pet names and so on. Such a list might be stored in a database of other bracketed entries also, and wherein a data node 953 that is dropped into the workspace can then through interaction be configured to point to such database. Such a database may be public or private and identified to the data node 953 upon interaction. In this configuration where user data privacy is to be maintained, the data node 953 provides access only to public possibility databases from which the influence pattern 951 is populated. That is, the population processing node 949 receives influence pattern text with bracketed entries therein and responds by turning to the public database of possibilities and uses random or pseudo-random (e.g., round robin) selections therefrom to fill or populate the influence text of the influence pattern node 951.

A support processing node 947 is then added and connected to receive the influence text from the search node 945 (i.e., the personal influence text) and from the population processing node 949 (i.e., the storybook context and structural limitations along with population text). The support processing node 947 is dedicated to merge with influence balancing if needed, incoming influence sourced text into a single combined influence data that is then delivered to a dropped in text generating AI, an AI node 955. The AI node 955 is selected from a plurality of possible AI nodes through creator scrolling and selection. The AI node 955 selected is one pretrained to respond to influence to input text and write story text. A more general purpose text generating AI node might also be selected or a more specific one that only generates for storybooks might alternatively be selected if they exist. If not, a creator can interact through upload their own software model and linked to the AI node 955 icon through interaction with the AI node 955. The creator may also visit an AI training visual interface where training datasets are selected and uploaded, and the hosting system carries out the training of neural network based or software based AI elements. This can be done from fine tuning training of a baseline pre-trained AI element provide by the hosting service or the training can be from fully untrained AI elements, and wherein the training is conducted by the hosting service.

All output generated by the AI 955 will be then be based on input influence from the search node 945 and the population processing node 949. In addition, prior generated output of the AI 955 is also delivered to provide influence to a current generation via the segment delay node 959 (added via drag and drop interaction with the icon representing the segment delay node 931). The segment delay node 959 through creator interaction is also capable of being operable to prepare the generated output text into an influence text format for balanced merger with other influence text by the support processing node 947. In addition, the segment delay node 959 may be configured to use combine all previously generated segments of text output from the AI 955 into a single cross segment influence data for delivery as influence to the support processing node 947 as each segment in an overall segmented generation flow are produced.

That is, some topologies may be exercised a single time to complete an overall AI generation objective, such a single page brochure. Others benefit from progressing with step by step, segment by segment flow such as in an overall segmented AI generation objective such as a storybook where each page of an electronic storybook comprises a single segment wherein according to a first sub-topology, a first sub-segment generates a paragraph of text, while the second sub-segment generates a single image which is combined with the text into a single page format and presented to a child. After reading, the child may select a “next page” button, for example, and another segment or page of the storybook is generated. Such an electronic storybook could then be unending.

In particular, a page of storybook text in one configuration of FIG. 9, is generated by the AI 955 within the first sub-segment topology illustrated above the sub-segment line 905 and delivered via secure communication linkage, a link-A 957, to a link-A 961 within a second sub-segment (the sub-topology below the sub-segment line 905) wherein an associated image is generated for inclusion on the page. To accomplish this image generation within the second sub-segment, the creator drags and drops, in addition to the link-A 961 (which can be interacted with to define the security levels needed for the link), a support processing node 951 configured to extract from the output text generated by the AI node particular influence text to be used for the image generation. Such particular influence text and pattern based influence text from an influence pattern node 969 are merged in an influence balancing manner by the support processing node 967.

The merged and balanced influence text output of the support processing node 967 is then delivered to influence an AI node 973. The particular functionality of the AI node 973 is selected from many options or uploaded (possibly after training or via hosted training) to respond to input text and generate an image based thereon. In addition, the AI node 973 is selected to generate an image output that may be population tailored by a population processing node 975 that utilizes private image data. In this example, the AI node 973 operates without having access to a user's private data as a hosted service and the population processing node 975 securely operates on a user's device, such as a cell phone, tablet or laptop and with population based on user's private image data stored locally on a user's device or in from their secure, private cloud based storage.

The influence pattern node 969 might carry image characteristic limitations such as image style, palette and a requirement for a common subject to be included. For example, in a storybook about a dog, influence pattern text might include “image-resolution: 720p; palette: monochromatic-A; style: colored-pencil-sketch-C” indicating a particular standard monochromatic color palette be used to generate a pencil sketch with a 720p resolution and size ratio. Influence patterns may also be configured through interaction to include various influence data relating to episodic, content and other limitations, obligations and structural aspects that may be introduced once or be applied across all or only select segments as well. To accommodate this, upon interaction with the influence pattern node 969 various types of entries therein may be made and applied to all segments or just one or a select few. If applied only once, often, the influence is carried forward via generated output to input influence flows such as via the link A 957 to the link A 961 (herein referred to as “inner-segment influence”) or via the delay node 959 (herein referred to as either “cross-segment influence” or “inter-segment influence).

Also as with the AI node 955, the image generating AI, the AI node 973 is configured to run as a hosted service and as with the text generation is made without access to a client's private data. To accomplish this both the AI node 955 and the AI node 973 generate output that is readied for population. The AI node 955 training involves training datasets that included bracketed words and word sequences along with topic tags therein. Default text is also provided should a local population not desire to assert a replacement of a particular tag or all tags for a certain storybook generation. Training datasets are prepared with support processing based on a set of category tags in a standard population database structure shared with the client. For example, training data that includes “the beagle growled” might be processed to replace that text with “the <dog: beagle> growled.” Later, once fully trained based on such prepared training data, the generated output from the AI node 955 might be “the <dog: beagle> licked his hand” and such output is then delivered via the link A 957 and link A 961 to the population processing node 963 operating within the user's device. The population processing node 963 access a personally tailored bracket database to find an entry for dog with a local preference for spaniel. The population processing node 963 replaces the bracketed text in the generated output to read “the spaniel licked his hand.” If the population processing node 963 servicing a particular tag finds no preference within the personally tailored bracket database of the user, then the brackets and tag are removed to read “the beagle licked his hand.” And where the population processing node 963 finds several possibilities of preference associated with <dog> such as spaniel and terrier, the population processing node 963 picks one of the two at random for the population.

Similarly, the image generated by the AI node 973, based on input influence text from the influence pattern node 969 and from the text generated and prepared by the support processing node 971 (merged and balanced by the support processing node 967), is also generated in a state readied for population as a hosted service element. Here, layers of the image are produced, for example, such that a single image comprises a plurality of image portions for easy population. Skin layers for tone population can be added as a layer for processing, as can eye color, hair color, dog coat pattern and coloration and so on. Then, a population processing node 963 through interaction can be configured to apply associated layer tag private information to personalize the images to meet a child's expectations. For example, a <skin-tone: tan-1> might be replaced with a light-2 skin tone that corresponds to that of the child extracted from personal photos along with eye, hair color and so on. Then all of the image layer pieces can be easily replaced or populated with the default generation suggested depending on the local personalized image element database entries present. Hair and eye color, for example, might be retained with that originally generated as a default, but for another character with an entry, substitutions are made via a population processing by the population processing node 975. Random choices can also be made if multiple preferences are present for a tag entry. When layers have been populated, the population processing node 975 overlays them one atop the next in an appropriate order defined by the AI node 973.

Personal population possibility databases for all data types even beyond text and image involves starting with a common tag database structure used to train AI nodes that generate population readied output. But once such structure is download to a client, support processing nodes typically running on the client device gains access to private data to extract there from preference data corresponding to each particular tag within such database. A trusted hosting service may also perform such database preparation and download it to the client device for future population use. For further and more detailed explanation of another image and text population of population readied generative AI output, please see the example set forth and described with reference to FIG. 3 herein.

The populated outputs of the population processing node 975 and the population processing node 963 are both delivered to an output presentation formatting node 965 which fits the populated text and image into a single page format delivered to a user via a storybook page frame display. At this point, the segment's (page's) overall topology has completed a page segment. Instead of immediately repeating the first and second sub-topologies again to generate the second segment (second page), the creator inserts a pause at the end of the segment completion (after the first page display) to await a child's interaction signifying a next page desire. This is accomplished by a break node 977, which through interaction can be set to continue only should the child deliver a next page command via user input. With such indication received, the first sub-segment followed by the second sub-segment topologies illustrated repeat and through further inter segment breaking, the storybook can progress to the last page (segment) or continue in an unending story telling fashion so long as a next page indication from the child reader continue to be received.

Once completed, the entire storybook can be shared. But because it may contain private data that is not desired for sharing, a parallel unpopulated version of the full storybook is also saved. Then, a child can share a populated storybook with their family members, while sharing a well liked storybook in a more generic storybook form including population readied but not yet populated versions of all text and images on all pages. Then, a receiver of the shared book, another child in another unrelated family can accept the storybook in the generic form as is by removing bracketing and so on to accept the generated text and image proposals, or replace them all using their own private preference tag database filled using their own private data. In this way, sharing can be accomplished without exposing a child's or their families private information and still be tailored in a personalized way by a recipient other child using their own private information. Using DRM restrictions, the hosting service may act as a clearing agent for such output. That is, the hosting service may assist creators in training new AI elements, creating AI based overall solutions, and allowing clients to share specially liked generated content in population readied form—and all while managing DRM issues and guaranteeing privacy concerns are met.

The present invention also facilitates after-purchase training carried out for example at a user's premises. Therein, an AI based device or a mobile unit provides various services. One such service involves after-purchase training involving a training AI based topology that assesses a user and user's progress to deliver tailored training. Such training may extend across sessions and as the user requires. For example, a user may later request a particular training focus, and the underlying AI topology adapts to so provide.

Other AI topologies include, for example, an installation AI topology that evaluates the user, identified user preferences and user environment and, based thereon, directs a tailored installation and configuration. use of a generative AI installer followed by subsequent local training. For example, AI topologies may be created and deployed with a robotic product and with associated AI topologies targeting other user devices such as a cellphone or laptop. Yet other topologies operating independently or in portioned form may be available for host operations. When a user then buys the robotic product (e.g., a robot), a variety of installation, configuration and usage operations defined by such associated AI topologies become operational when needed to enhance a user's experience with the robotic product. Such topologies may also collect operational anomalies, user complaints and satisfaction information to enable both topology enhancements and robotic product next generation designs which may be identified by generative AI to designer/creators. Further with AI assist, such recommended modifications or enhancements to topology may take place automatically or with creator confirmation.

For example, a user purchased commercially available robot can receive all types of topologies prepared for use with the robot by the manufacturer or by any creator via secure interaction with host circuitry. Such topologies include robot configuration and training often from the manufacturer, and carrying out particular actions and activities design within creators' topologies that the user may find pleasing or needed. Also, primary AI topologies, generative AI based software model nodes, and various other nodes underlying such topologies may be preconfigured at the factory, while others await downloaded during and after installation operations. Various private user data from a user's data warehouse or local device dataset collections are accessed in accordance with topologies associated with the user to quickly tailor a new robot to meet the needs and expectations of the user.

Regarding after-purchase training, the creator's display 901 can be employed in one configuration, wherein the format output 965 is associated with the creator's display 901 residing on a particular device selected during icon interaction and configuration during topology creation. That is, by right clicking on the format output 965 after its icon has been dragged and dropped onto the screen/display 901, the user interacts to select a location where the output is presented—such as a screen layout, speaker selection, or any type of output device including a printer or a robot. Such output need not be visual or human consumable. It may also comprise control signaling to affect, for example, a robot circuit element or cause a local launch of a robot software application or another of the robot's own topology specifications stored therein. For example, the generated output might target a particular robot of a user with output formatting that directs, for example, coordinated robot voice, lip, eye, forehead and face motion elements, or launch a robot's local speaking topology which utilized the formatted generated output to carry out such a speaking performance.

In a further example, a default set of robot topologies are preinstalled within each new robot. Once unpacked and activated, pursuant to an installation and configuration AI topology, updates, configurations, replacements and enhancement topologies and underlying nodes are retrieved such that the robot becomes tailored to anticipate a user's needs. In addition, over the course of operations, if the user makes a request to the robot to perform a currently unavailable activity not identified in the stored topologies, the installation topology may activate and search for a topology offered for download via a host circuitry supported platform, for example, to satisfy the user. A user may also interact with the robot such that the robot may download topologies and carry out activities and gauge whether they are to be retained or discarded depending on user response data gathered by robot sensors and voice to voice interactions. That is, a robot camera may look at the user's facial cues to determine how pleased the user may be when a topology is carried out. Robot microphones may gauge audible cues indicating annoyance or being pleased. And using its microphone and speakers, a robot topology may interact to directly ask if the user wants to keep the demonstrated behavior or not, and gauge cues and underlying text to make local topology discard decisions.

The creator can create such robot topologies as described further with reference to FIG. 11 below. Such topologies may run outside of or within the robotic product, e.g., within host circuitry, creator system circuitry, or other user device's circuitry such as within a cellphone. Personalization may also require compensation. An installation AI topology may offer a variety of choices for topologies to be installed wherein particular AI node options may be free or require payment. For example, a celebrity voice generative AI may be an offered option requiring payment for use within the robot along with a default voice generating AI. This same installation procedure applies to any topology installation on any user device. A storybook tablet computer based AI generative topology might, on installation or through modifications through settings interaction, may offer celebrated comic strip characters for use with story text and image generations. This may take the form of gaining access to a different set of AI nodes that are trained for such comic strip character integration, or it may comprise content prepared for population ready enhancements. The offer may also involve an entirely different topology alternative.

In other words, no matter what system or device a topology may operate on or at least partially on, advertising offers during topology selections, operations and installations (and at any point thereafter through settings modifications or otherwise) can be accepted, paid for and the entire process managed by the host operations supported by host circuitry with or without assistance of the user, creator or third party system on which an installation or operation underlies.

In addition, a creator may select several standard topology or topology node alternatives with varying DRM costs and obligations associated therewith that can be selected which conform to the creator's vision of the overall generative objective. These several alternatives may be the only options of alternatives available or the creator may allow exploration of all options to be used as alternatives as well.

Such topology alternatives might involve a paid use of Arnold Schwarzenegger's trained voice generating AI, wherein when the topology configuration is installed responds to outside influence in the form of a bump sensor and go through a random or round robin selections of Arnold Schwarzenegger's catch phrases, e.g., “I'll be back” “Hasta la vista, baby” “Stop whining” “What a pain in the neck” “You've just been erased” and so on. Also, if a robot owner accepts a one-time charge, the host system conducts the download on behalf of the creator who has authorization from Arnold Schwarzenegger's verified by the hosting service, and the hosting service collects the fee and allocates a sharing thereof between the hosting service, Arnold Schwarzenegger, and the topology creator.

In some generative AI node configurations, such and other types of 3^{rd} party ownership based enhancements may be made by training replacement AI nodes for substitution such as using a celebrity's 3D image data and using that to train a video or image generating AI. Alternatively, such celebrity data may be provided to a user's device which constitutes population filling elements used by population filling support circuitry based on population readied output. In addition to such population filling as discussed with reference to FIG. 3, other population approaches are contemplated. For example, a creator working in authorized agreement with a celebrity may train a generative AI to alter an incoming standardized voice stream into a celebrity sound alike generated output. Such population filling as this is thus conducted by a generative AI node that may be become available upon receiving a use payment. Another approach involving training, would might be more complex, such training an additional AI node to be inserted into the topology that generates a video output with synchronized video characters talking with voice output. The additional trained node might receive as input, the standard voice output along with subtitle text, translate such text to a user's native language and resynchronize (lip-synch) it with another celebrity's (or even the user's own) voice.

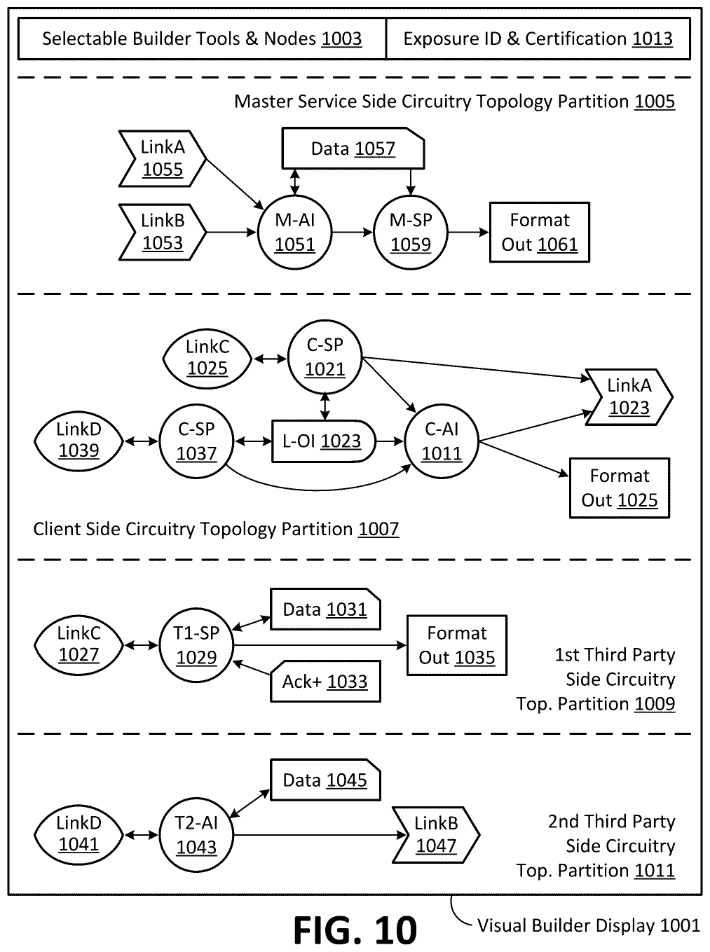

FIG. 10 is topology diagram illustrating one embodiment of a partitioned topology architecture defined through a visual builder interface (or defined in whole or in part through a topology builder SDK and displayed visually) in accordance with various aspects of the present invention, wherein topology partitions define functionality to be carried out on a plurality of systems such that security, privacy and anonymity can be maintained and certified. Therein, a selectable set of builder tools and topology nodes 1003 can be used along with or instead of the topology builder SDK to create the four exemplary topology partitions illustrated, i.e., a master topology partition 1005 defined to be implemented on service side circuitry, a client topology partition 1007 (defined to be implemented on client side circuitry), a first third party topology partition 1009 (defined to be implemented on first third party side circuitry), and a second third party topology partition 1011 (defined to be implemented on second third party side circuitry). For further details regarding the set of builder tools and topology nodes 1003, please refer to the description provided in relation to the builder tools and topology nodes 903 (FIG. 9).

In general, a potential client interacting with a secure hosting and certification service may locate through browsing, search or hyperlink, for example, a client's topology partition specification that forms part of a multiple topology partitioned design for serving an overall secure AI supported objective. Once located, the client topology partition, such as the client topology partition 1007, can be downloaded and operationally launched on client side circuitry. Similar location, download and launch of the first third party topology partition 1009 can be carried out by and upon a first third party's system circuitry. Likewise, download and launch of the second third party topology partition 1011 can be carried out by and upon a second third party's system circuitry. The master side topology partition 1005 may be serviced by an independent dedicated computing system or be hosted by the secure hosting and certification service that also supports many other topologies and topology partitions supporting corresponding other independent overall AI objectives.

With the present exemplary partition design, the master topology partition 1005 need not be involved until one of the client side topology partition 1007 (many clients may have downloaded their own copy) has successfully completed its functionality. As illustrated, both a client side support processing node 1037 and a client side support processing node 1021 interact to privately gather information for use by a client side AI node 1011 in making a client side decision (such as an approval or verification) and/or generating client side data (such as a summary or other aggregation). In some configurations, only if certain requirements are met will the client side topology partition 1007 communicate with the master topology partition 1005. In others, only approval, rejection or the summary or aggregated output be sent via a secure keyed communication linkage defined between a link-A 1023 and link-A 1055. In such ways, a client can decide to only to expose their private information should they be assured that an offer for master service will be provided. From the master side standpoint, no support need be given nor exposure to client data when client's fail to meet the requirements for service or fail to carry out the interactions required by the client side topology partition.

Specifically, the client side support processing node 1021 request and receive information from a client via local output influence 1023 (e.g., in this case, typically user input data) and also interacts via a link-C 1025 and link-C 1027 secure communication pathway with operations of the first third party topology partition 1009. Such operations involve a user providing authorization and authentication and based on private client account data 1031, a first third party support processing node 1029 gathers and produced an appropriate data output that is delivered via the link-C 1027 and link-C 1025 pathway to the client support processing node 1021. But if the first third party support processing node 1029 recognizes a deficiency that will cause a failure in the overall AI supported objectives, the first third party support processing node 1029 may reject the request, send no data, and, in this way, help secure the client's account data. In other words, only so long as partition thresholds or conditions are met within each partition will secure private data or any summary, excerpt or output generated based thereon will be forwarded and thus act to cause the attempt to accomplish the overall objective to terminate.

Assuming that such threshold or condition is met, the third party output is received by the first third party support processing node 1021, the process continue with the client side support processing node 1037, via a link D 1039 and link D 1041, request from a second third party AI node 1043 an output based on the private data 1045. Here, the second third party AI node 1043 does not challenge the output generated as being sufficient for the overall topology decision making and delivers so long as authorization and authentication concerns are met, and output that is combined by the client side support processor 1037 along with certain of the client's local outside influence 1023 to generate yet another input into the client AI node 1011. Based on the three inputs, the client AI node 1011 delivers a client output. If the client output 1011 meets an adequate threshold or condition, the client output is delivered via the link-A 1023 and link-A 1055 an input to a master side node AI 1051. The master side AI node 1051 also access private master data 1057 and additional secure data produced by the second third party AI node 1043 via link-B 1047 and link-B 1053 such as an acknowledgement with or without verification data.

The master side AI node 1051 generates based on the three input sources a master output for a master side support processing node 1059 which prepares (from such master output plus further of the private master data 1057) output that is delivered to an output formatter 1061 for presentations to both staff supporting the master service and to the client. Similarly, the first third party support processing node 1029 also delivers output to an output formatter 1035 for selective presentation to third party staff. The client side AI 1011 also delivers generated output to an output formatter 1025 for presentation to the client (or client's staff).

In this configuration, all communication between links is carried out in a secure matter set forth in detail with reference to FIG. 4. In addition, based on the actual data flow via such links, a hosting service operating independently of the master service provider can provide and control private information exposure, sharing and certify the details such that every topology partition's exposure certification is known and understood by all parties before participating in the overall topologically defined service.

As previously mentioned, by right clicking on any of the graphical elements that populate a topology partition, the creator can select from many predefined node configurations and selections. Such interactions are described in more detail in association with FIG. 9. In addition, a software SDK (Software Development Kit) provides an interface through which any overall topology (whether segmented, sub-segmented, partitioned or not) can be defined textually, for example in a netlist manner. Either way, the illustrated visual builder display 1001 can be used to display and permit further modifications thereto. The netlist format can then be output in a form that may be used by a creator to develop their own personalized interface thereto. To that end, although most support processing nodes are curated and prepared by the host service, third party support processing nodes may also be uploaded but they require additional curation and incur fees related to such services.

For further clarity, consider a bank lending infrastructure with an overall AI objective of evaluating a potential borrower, a client, wherein the bank does not want to waste time or be exposed to potential borrowers that are not credit worthy in their view. To accomplish this, the illustrated topology partitions are configured, wherein a client topology partition 1007 interacts independently and privately with the potential borrower to gather financial information necessary to determine credit worthiness. But instead of making this decision, being exposed to private financial data, and staff being involved with credit unworthy queries, at least most of the credit worthiness process takes place in a secure client side topology partition 1007 operating within a user device. Specifically, within user device circuitry, the client AI node 1011 is fed trusted and personal financial data extracted from at least a first and a second third party such as a credit reporting service and the internal revenue service via secure communicative coupling and in accordance with topology partitions operating on circuitry within the first and second third party systems. If the client AI node 1011, trained to evaluate credit worthiness, yields summary worthiness output such as a maximum per month loan payment amount being above a certain threshold, a legitimate credit worthy potential borrower has been found and who justifies an approach to the master topology partition 1005 to fully complete or at least partially complete a lending transaction.

And if a credit rating is below yet another predetermined threshold, a credit reporting service third party may even refuse delivery of associated information as that threshold by itself might identify credit unworthiness. Thus, the processing and AI involvement across partitions can be in parallel and series. Series allows for early termination without bothering the user or other third parties when one third party alone is capable of derailing the overall objective. In this case, after gathering just enough client information to drive an interaction with a third party credit rating company, the third party credit rating company's topology identifies a threshold or AI conclusion of minimum acceptability by inputting various user characteristics stored privately by the third party credit rating company.

Such output is not delivered to the client topology if it does not meet a threshold of credit worthiness required by the bank lender (as defined within a support processing node or AI node of the third party topology partition). Otherwise, the output is delivered to the client topology, and just enough client information is gathered to interact with the internal revenue service to gather earnings and debt data. According to the internal revenue service's own local topology nodes, a determination is made according to the bank lender's thresholds that may again terminate the overall process such that gathered private data need not be delivered to the client system if it clearly will derail the overall process. If it is sufficient, then the client side topology partition considers these two and many other sources of financial information including gathering data directly from the client such as monthly rent, other loan information, current earning information and so on. All of this data is considered by the client side AI node 1011 which generates credit worthiness output indication data which may still hide the underlying client financial data underpinnings. This credit worthiness output indication data then gets delivered for processing in accordance with the master side topology partition 1005 which may then make tentative offers of interest rates and repayment amounts that might be due. If acceptable, the client may only then release the specific private financial information retrieved and provided for the bank lender's staff's final review and approval.

For some additional clarity, consider a wealth management infrastructure with an overall AI objective of evaluating a client's asset portfolio periodically so as to estimate a management fee that is based on the net worth of the client's assets' net value under management, wherein the wealth management firm does not want to waste time or be exposed to potential clients without significant amount of qualifying assets in their view. To accomplish this, the illustrated topology partitions are configured, wherein a client topology partition 1007 interacts independently and privately with the client to gather financial information necessary to perform an ongoing determination of determine asset/portfolio size and valuation estimates as underlying market valuations change.

Instead of requiring staff to manage minor clients (unnecessarily exposing them to private financial data and risking claims of bad practices) and instead of abandoning all small clients who may develop into big clients and never return, small clients may download a hosted topology that performs much of the management tasks including delivering advice and daily assessments of holdings, all managed and generated by the client side AI topology operating on a user's system. For example, such topology delivers daily (prompt) status updates, provides generative AI advice on optimizing returns or diversity and delivers constant caveat emptor messages to minimize the impact what might be perceived as bad AI advice and noting that such lower asset holding client's either increase their assets under management or choose to terminate should they not be willing to accept such risks.

In this way, a private financial service may safely extend management reach to sprouting small clients to help them grow to being big clients using their own created client side AI topology which may be downloaded by anyone without restriction. If after configuring the topology, a big client is identified or if a small client becomes a big client in time, the client side topology may reach via a hosted topology for big clients to place staff on notice. Staff may then invite the big clients to download a privately circulated topology which includes human staff assistance and other extended management services.

In addition, even using the small client side topology many important advisory and management advice can be delivered. And when even a small client requests assistance from staff, it can still take place but perhaps only with payment collections associated therewith. For example, a small client requests via their small client side topology to add or extract asset holdings (e.g., buy and sell requests) the host side topology may service such requests automatically, with human staff assistance, and for a transaction fee assessment. Of course, at least most of the client side topology interactions, e.g., portfolio size evaluations and so on, are processed in a secure manner (such as described in relation to FIGS. 4-5) all carried out in accordance with the small client topology partition, i.e., within a secure client side topology partition 1007 operating within a user's device.

In one related configuration, within user device circuitry, the client AI node 1011 (on setup or as asset holdings are accrued) stores is fed trusted and personal financial data extractions ed and asset details such as equities, bonds, real estate, etc., from at least a first and a second third party such as a stock brokerage service and a savings bank service via secure communicative coupling and in accordance with topology partitions operating on circuitry within the first and second third party systems. If the client AI node 1011, trained to evaluate portfolio size and value estimate, yields summary of net worth output such as assets under management being above a certain threshold, a legitimate potential portfolio net worth has been found that justifies an approach to the master topology partition 1005 to fully complete or at least partially complete a wealth management fee transaction.

And if a net worth falls below yet another predetermined threshold, a banking service third party may even refuse delivery of associated information as that such threshold by itself might identify paltry net worth. Similarly, a stock brokerage service third party may refuse to deliver associated asset net worth information if in their analysis that threshold by itself might indicate insufficient assets or low net worth for the client. With these and numerous other approaches, secure partitioned topologies operate in limited, coordinated manner to carry out overall topology interactions in compartmentalized ways liability, processing justified, and staged sequences with an added bonus of limited access to each party's private data and while accomplishing each party's own goals while minimizing unnecessary human interactions.

FIG. 11 is a diagram illustrating an exemplary AI training topology designed in accordance with the present invention wherein a baseline or untrained AI node is trained by a hosting service utilizing both selected groups of training data from pre-prepared training datasets and also uploaded training datasets of a creator with ownership and authorization concerns curated and certified by the hosting service. Therein, a creator uses a set of selectable builder tools and nodes 1103 (in a drag and drop manner such as that described in detail in relation to the builder tools and topology nodes 903 of FIG. 9) to construct the illustrated training topology when the hosts and other creator's pre-trained AI nodes are not available, too costly, or provide insufficient training. Training datasets are produced and applied via the training topology illustrated within a creator's AI training display 1101. Herein, either a previously trained AI node, such as the baseline trained AI node 1131, or the untrained AI node 1133 can be correspondingly fine tune trained or fully trained by the host service as the creator's designed topology indicates.

Specifically, a creator's personal training dataset can be uploaded, i.e., as specified by a data icon interacted to define an uploaded training dataset node 1111. The hosting service uses the uploaded dataset in a series of internet search attempts to check for origin information which may be found there. In addition, a creator may upload ownership and/or authorization information provide by an owner of at least a part of the dataset along with triggering a required break 1119 wherein the host service can evaluate and verify that the ownership or authorization for the full dataset upload is claimed. In other words, a creator may have dataset materials from third party owners or have authorizations that must carry over to DRM uses of all generations made by any AI node trained using the uploaded dataset.

The internet data search carried also attempts to identify discrepancies that the creator must address before training will continue. All of such processing is carried out under the direction of the rights support processing node 1113. And, for example, detection of third party ownership of training data and authorization that extends only to private use by the creator without receiving usage payments will convey such a usage restriction on any topology in which such trained AI node happens to play part of. In addition, if a subset of the uploaded training data is identified as problematic, the creator can delete this subset and gain approved authorization to train. Otherwise, the subset or entire uploaded training dataset requires an accompanying ownership authorization upload. This may require a delay for seeking such authorization from underlying owning persons and entities. This entire process is also part of an ownership and certification process 1105 carried out by the host, and will include establishing any required setup of DRM requirements such as for payment collection and distribution.

Once the break 1119 is released by the rights support processing node 1113, the certified uploaded training dataset with any underlying rights management issues applied is delivered to a merge support processing node 1125. The merge support processing node 1125 may process such training data to identify population readiness indicators if needed, or merely merge the certified uploaded training set with extracts from the host service's pre-certified training datasets 1123 which may or may not include population readied training dataset. With the merger, the combined training datasets are passed to both a comparison node 1127 (which may be support processing or AI based) and an influence preparation support processing node 1129. The influence preparation support processing node 1129 then passes the prepared influence for each training item to a baseline trained AI node 1131 (or untrained AI node 1133) in a sequential manner and where the generated output is compared with the original training item and with differenced therein being trained backward through the underlying neural network(s) within the baseline trained AI node 1131 such that a better chance for a more correlative generation can be expected. The training approach is standardized as a default according to the host service, but can be modified through a settings configuration interaction from the selectable builder tools and nodes 1103 (not shown). Once training has ended, the resulting trained AI node is then accessible by the creator through interactions with a dragged and dropped AI node icon associated with the trained AI node as part of a topology construction in a manner in which all icons are associated, e.g., the AI node 955 of FIG. 9 being associated with the newly trained AI node.

Employing the techniques taught by the present invention, celebrities, artists, writers, and others can create, use and distribute personalized AI nodes and share personal dataset for further training of other AI, contributing to influence patterns, and for filling population readied generated output of all data types. that the host circuitry and services management of their personal contributions along with associated DRM, secure environment, and assured revenue collections, will allow further outlets to monetization and access to their creative work, their styles, fashion, designs and related personal information in ways never before available. For example, a social media influencer may interact with a hosted topology which extracts from personal storage of the influencer data used by the topology to create a set of freely sharable and a set of payment required topology assets, including various personalized nodes, training datasets, population data (for population readied filling), and even fully tailored topology offerings. The topology then queries and advises the influencer as to how to price and control or limit authorizations, and, once complete, transfers the influencers offerings in a posting within a hosted posting service where fans can pay fees and gain access to use pre-tailored influence topologies and in creating new topologies or for populating and tailoring others with influencer watermarking.

Such offerings often have not only a commercial value but also political and social relevance and, further, social influence value. Thus, such celebrity offerings can serve as “influence” inputs to generative AI topologies that create various multi-media outputs, for example. Such celebrity offerings can also be used as inputs to AI topology based product designs wherein a celebrity style, design idea, fashion sensibilities and product knowledge is taken advantage of during production of various commercially sold products and various user consumable media such as music, movies and entertainment.

Regarding training, a celebrity dataset portion of the celebrity offerings is associated with authorization information and be added as a celebrity dataset 1111 that can be used to train an AI node. When selected for use, a required break 1119 is triggered wherein the host service can evaluate and verify that the ownership or authorization and curate out malfeasance such as creator attempts at generating nudity related fake outputs based on the celebrity dataset. In other words, a creator (tool or software) may have dataset materials from third party owners or have authorizations that must carry over to DRM uses of all generations made by any AI node trained using the uploaded dataset.

During the authorization step on a break provided, the celebrity, regarding the training dataset (along with any celebrity offering), and creator can also reach a deal where fee splitting for particular DRM based usage with watermarking (for living celebrities as there may minimal need otherwise) is approved. That process happening as a hosted service allows for certification and guarantees provided which satisfy all involved.

That celebrity dataset is then uploaded, tested and made subsequently available to be consumed as part of the creator topologies so specify. The creator's overall topology or any topology that involves an AI node which is trained by or otherwise extracts from their dataset, database or any other celebrity offering, with trigger a required revenue flow to the celebrity for client usage of any celebrity topology or any topology in which any other portion of the celebrity offerings happen to be included therein, including those receiving celebrity data based training or content elements. The hosting service also provides such management.

Thus, a celebrity using client topology with access to their private data stores, uploads their gathered offerings in forms readied for including with topologies (e.g., his/her datasets of all types, image, voice, video, sound effects they make, designs they create, fashion styles they popularize, social statements they promote, and so on) and including particular personalized celebrity full or partial topologies.

The hosting service then associates whatever DRM requirements the celebrity desires. In some scenarios the celebrity might even employ a watermark (in visual form or other forms) indicating ownership. In addition, celebrities may be involved such that they get a final approval cycle of any posting or final use of any output generated for commercial purposes, and can even impose extra charges for commercial use, enforce per use charges, enforce use only by an authorized group within a client organization, implement restricted use based on commercial agreements, etc. Then a creator uses the hosting service to train up, for example, an AI element from that training provided using the celebrity dataset. Such training can be for example used to train a generative AI element that is already baseline trained (partially trained).

When the hosting service recognizes that the celebrity training dataset is being used, the hosting service takes the celebrity dataset DRM obligations and transfers it automatically to the AI element in which the celebrity's rights are therewithin. Next, that celebrity AI element if dropped by that or any creator into a topology, instantly transfers the DRM burden to the topology.

More particularly, in one configuration, a different creator drags and drops an AI node icon on the builder workspace (shown in FIG. 11) and right clicks to interact. Then a text to voice search restriction is added reducing the set of available AI node selections to be associated with the AI node icon. Further, the creator can restrict the pool of selectable AI nodes to celebrities, and the set shown drop substantially again. The creator then identifies certain DRM restrictions that are preferred (by the celebrity, for example), and the set of possible AI's to use drops again in size. From there a particular celebrity (such as, for example, Arnold Schwarzenegger or Beyonce) text to voice can be browsed in—or the whole thing done by searching the name of the celebrity (such as using the search string “Arnold” for example). Upon selecting and associating the celebrity's (for example Arnold Schwarzenegger's) pre-trained AI element with the AI node icon, the host service automatically follows the DRM rules for that element's use in any topology added.

Any DRM associated with a topology may be selected by a client (the user of the creator tool) in the scheme described herein. For example, a creator (using the creator tool) creates a topology, and as part of that process, drags and drops an icon for AI node, the creator then creates a list for the end user (i.e., the client) of reasonable DRM celebrity text to voices from which the end user can select to use, substitute, or employ to enhance a text to voice generation need.

The hosting service in one configuration also hosts not just the creator's topology but also the output created. By doing so, personalization data may be hidden or deleted and default and perhaps free counterpart generations may be available until payment has been received to unlock such personalization. The hosting service in another configuration migrates the personalization to a remote device such as a specific end user's computer or mobile device in response to a purchase event.

Various other aspects of the present invention supports renting of AI node operations, such as for one time or frequent use over a certain period of time. With renewed payments, such time may be extended or usage repeated as needed. Such payments may be associated with any other type of topology node, or assessed against entire topologies. Extending the concept of rental, this can be associated with generated output as well as the generating topologies and elements. For example, a user manages to create something highly enjoyable and decides to post it for other user's consumption, but requiring a rental fee which is distributed between the user, the underlying topology creator, the underlying owners whose data was utilized within the topology, and the hosting service.

The DRM means can be employed to enable, disable, terminate rental of AI models and datasets, as necessary, in a topology. In addition, a creator or user may “rent” a trained AI node or training dataset associated therewith. This rental style compensation model is but one recognizable single use DRM compensation functionality and various other payment schemes are contemplated.

Moreover, a rented topology related elements and generations may be versioned with updating managed by the hosting service to keep up with latest and supposedly better performing versions. The usage of an AI model or dataset for a window of time is merely one compensation requirement an owner may allow and the hosting service carries out. Others include one-time use, pay per use, pay not just for use but also for any distribution of output, for non-commercial use employing one DRM, commercial use employing another DRM rule set and so on. Also, the hosting service supports visual and hidden watermarking to reveal faking and to cause any player/viewer/audio/video output device to respond by visiting the hosting service and abiding by the DRM requirements before allowing playback of something created. Other hosting service include “fake” flagging by introducing notices, notifications, etc., such as “This is not the actual actors but simulations” required to be added to prevent confusion.

In one configuration, a commercial hosting service provides best in class untrained AI nodes and is not too keen to add a third party's untrained AI nodes unless favorable terms are negotiated and overall financial impact might be positive. In another configuration, the commercial hosting service supports fully trained AI nodes created from untrained AI node offerings by third party organizations. These commercial hosting service conduct significant amount of training of their own untrained AI nodes and may decide to upload their AI models into the hosting service infrastructure, requiring hosting service staff curation.

When interacting with an AI node icon on the builder screen (FIGS. 9 and 11), a user can search to find such a fully trained AI node and link it to their AI node icon within their creator's visual workspace during creation of a new topology via the creator tool interface. The host service also provides a large selection of their own partially trained AI nodes for fine tune training, and also supports uploading of creator's partially trained AI nodes to receive the host's own fine tune training service. Partially trained AI nodes, as with untrained AI nodes, are trained in much the same manner by the host provided training service set up via the creator's visual training interface illustrated in FIG. 11. Untrained AI nodes may receive training in stages as well. A first doing the base training using a base training dataset, and the second training pass using fine tune training datasets. Moreover, training datasets may be applied to entire topologies and topology portions to fine-tune overall topology operations once all underlying AI nodes are fully trained on a single node basis. In this way, overall desired generative objectives can be reached.

For example, user text drives a first AI node to generate output text which, in turn, is fed to a second AI node that generates an output image, wherein, as can be appreciated, the first AI node output influences the second AI node. A creator may select a host provided partially trained first AI node, upload their own fine tune training dataset, and trigger the host service to fine tune train the partially trained first AI node to a fully trained state. The creator may then select another host provided but untrained AI node, uploads a full training dataset, and trigger the host service to fully train the untrained second AI node to a fully trained state. The training is not yet complete in many situations, as the influence flow between the first and the second fully trained AI nodes may not work yet as intended. The creator places both AI nodes in a mini training topology that may include a support processing node in the middle which reduces the wordy first AI node's output text into an appropriate tagged influence form. Then, the creator uploads fine tuning topology training datasets and triggers the host service to carry out the training. To learn, the host service's training involves not only providing feedback adjustments to the first and second AI nodes, but also makes adjustments as needed to the support processor for example by increasing or decreasing influence text tag lengths and so on. This overall training of course is simplified, as overall topologies become more complex with further support processing nodes and other AI nodes being involved. The creator merely though needs to select the full topology or subparts thereof, provide topology training datasets therefor, and the host processing service handles the training process and approach needed.

Instead of starting with AI nodes needing training on the training workspace, the process can begin in the topology building visual interface. For example, selecting an AI node icon on FIG. 11 using the creator tool allows through right click interaction, an association between that AI node builder icon and any one of the host's untrained AI nodes or any one of the host's partially trained AI nodes. Thus, such selection of AI nodes constitutes a starting point of the training or fine tune training process that will follow a creation of a useable topology.

The hosting service of FIG. 11. also provides what can be termed best in class untrained, partially trained, and fully trained AI nodes of all types. Such a variety of AI nodes is also supported or backed up by corresponding “behind the scenes” best in class training or fine tune training approaches to deliver a creator's best in class operation.

In addition, these types of selectable AI nodes, interactions with an AI icon reveal population readied versions along with fully populated, regular generation versions. Population readiness though may be a post generation function in some configurations, or it might be “trained in.” For generation of text, these options might be appropriate, but for images and video, this gets tougher to post process and therefore it is likely that the training will be to generate video layer elements and then the personalization will be implemented at some point to merge layers back together—for example by replacing layers with personalization counterparts or appropriate modifications.

For example, the generative video AI might be from a video to video AI. For example, a first AI writes a screenplay text while a second AI delivers a cartoon style video output using screenplay text to video out (text to video generation). Then a third AI takes the cartoon styled video out and transforms it to realistic video out (with GAN, Generative Adversarial Network, type AI node functionality for example). The cartoon video may be very low quality and frame by frame, the GAN type approach produces for example a 4K HD output. Next the generated output can be shared in a fixed and not yet personalizable output, or it can be distributed in a form that is readied for personalization. And this whole flow starting from an initial image to finally delivering a personalized 4k HD version can be integrated into a single topology and deployed, as appropriate.

Facilitating personalization in a topology with the flow described above requires frame by frame processing with introduction or manipulation of personable items/objects and in addition, changing the skin tone of certain objects or individuals. For example, for a cartoon video that is output frame by frame in layers, a background layer, first to Nth character layers, first to Nth middling layers, a foreground layer or two, and so on are processed. And each frame layer has focus, lighting, etc., parameters associated therewith that may be manipulated as desired. And on each layer may contain personalizable items such as skin tone and so on that need to be identified and set to required values based on options available. If this is conducted at the generated cartoon video output (perhaps by a fleet of generative AI trained to compose only one layer for example, or one generative AI that generates instead of one image (frame) output a layered version of the output, then such layers can be personalized as set forth in FIG. 3. This is but one approach of many.

Converting all the layers from a cartoon frame image to realistic frame image employing a generating AI to generate an output that can then be personalized in a described in FIG. 3 is another possible approach. A different approach is to analyze the cartoon, choose actors, background and related selectable features, and then generate a fixed cartoon output that can be ready to distribute. This can be further personalized with certain actors and background etc within the realistic video output, so that one can also distribute a fixed output product. Another related approach is to share personalization readied cartoon video with a user who can then personalize it or run it through a realism generating AI and add in personalization to get a personalized version to watch (consume) or store. The user can even rewatch the same output each time with different personalization applied, wherein such variation of personalization may be based on the user's private data, a bit of randomness, or it may also be based on celebrity personalized data swap ins and outs, e.g., employing celebrity data sets or celebrity data models. All of these approaches are possible while the hosting service has a locked relationship, wherein flow between generated output to player playback is facilitated. The hosting service such as a commercial operation will also optionally host output generated as well so as to provide frequent or periodic outputs based on personalization.

Moreover, in some embodiments, an artificial intelligence infrastructure contains host circuitry configured to offer to a plurality of creator systems a plurality of topology nodes to be selectively added via a visual topology builder service. The host circuitry is also configured to offer to a plurality of users generative AI operations corresponding to a plurality of topologies created via the plurality of creator systems. Therein, each of the plurality of topologies having at least two generative artificial intelligence elements each generating related but different output to service an overall generative objective.

In other configurations, the artificial intelligence infrastructure has host circuitry that offers to a plurality of creator systems a plurality of topology nodes to be selectively added via a visual topology builder service. Here, the host circuitry is configured to offer a visual output formatting service to constrain artificial intelligence generated output into a desired format to service an overall generative objective.

Another configuration, the host circuitry of the artificial intelligence infrastructure provides a first service based on a first topology, and with user circuitry is also configured to provide a second service based on a second topology. In addition, third party circuitry to provide a third service based on a third topology, and at least one artificial intelligence node participating within at least one of the first topology, the second topology and the third topology. The first topology, the second topology and the third topology together servicing an overall artificial intelligence based objective.

Other aspects of the present invention can be found in an artificial intelligence infrastructure, wherein host circuitry offers to a plurality of creator systems a plurality of topology nodes to be selectively added via a topology builder interface. The host circuitry based on output from the topology builder service generates a first topology and a second topology. The first topology is hosted by the host circuitry and the second topology is carried out on a user device. Therein, the first topology and the second topology are used to serve an overall generative artificial intelligence based objective.

Still other aspects may be found in another configuration of the artificial intelligence infrastructure. Here, host circuitry offers to a plurality of creator systems selections of a plurality of topology nodes via a topology builder interface. The host circuitry based on output from the topology builder interface generates a host side topology and a client side topology. Therein, only the client side topology utilizes certain user data to address privacy concerns.

In yet another configuration of the artificial intelligence infrastructure, other aspects can be found in an interface through which population readied output of an artificial intelligence node is configured to be received, with memory circuitry storing population data. Client circuitry populates the population readied output based on the population data.

Further aspects of the present invention may be appreciated in a user device having processing circuitry configured to receive generated output from a remote artificial intelligence node, with memory circuitry storing personal data. The processing circuitry being configured to selectively apply at least a portion of the personal data to personalize the generated output.

In another configuration revealing yet other aspects, a user device with processing circuitry receives generated image output from a remote artificial intelligence node, the generated image output being personalizable. Memory circuitry is included which store personal image data. And therein, the processing circuitry being configured to selectively apply at least a portion of the personal image data to personalize the generated output.

In another configuration, the artificial intelligence infrastructure utilizes host circuitry configured to offer to a plurality of creator systems a plurality of topology nodes to be selectively added via a topology builder service. The plurality of topology nodes including artificial intelligence nodes. Also, the host circuitry is configured to offer topology partitioning, wherein a first topology created for a first circuitry communicatively coupled via secure interaction to a second topology created for a second circuitry. The first circuitry being within a first system at a first location and the second circuitry being within a second system at a second location.

Further aspects are illuminated in an artificial intelligence training infrastructure. Therein, processing circuitry is configured to retrieve a first training dataset and a second training dataset, and at least partially trains a first AI node independently and at least partially train a topology that includes the first AI node.

In yet another artificial intelligence infrastructure, additional aspects according to the present invention may be found. Here, processing circuitry is configured to support a step-wise creation of a multi-node AI generative topology using various data. The processing circuitry is also configured to identify digital rights associated with the various data and convey the identified digital rights across the multi-node AI generative topology as the multi-node AI generative topology is created.

Other aspect may be found in a user device with first circuitry configured to provide first processing and first memory functionality, and second circuitry configured to provide second processing and second memory functionality. Therein, the second circuitry also configured to receive an artificial intelligence topology specification in encrypted form to avoid exposure of the artificial intelligence topology to the first circuitry.

In another configuration of a user device, first circuitry configured to provide first processing and first memory functionality, and second circuitry configured to provide second processing and second memory functionality. Here, the second circuitry also configured to receive an encrypted artificial intelligence topology specification and carry out operations using the second processing and the second memory functionality without exposing the operations to the first circuitry.

Other aspects may be found in an artificial intelligence infrastructure with a first AI based multi-node topology partition configured to select to interact with a second AI based multi-node topology partition, the first AI based multi-node topology partition being configured to operate on a first system while the second AI based multi-node topology partition being configured to operate on a second system. The first AI based multi-node topology partition configured to perform functionality based on private data collected from the first system, wherein the first AI based multi-node topology partition selects to interact based on an outcome of the performed functionality.

Yet other aspects of the present invention are presented within another artificial intelligence infrastructure. Herein, a first artificial intelligence based topology configured to collect a person's personal data and generates from the personal data a plurality of personal topology elements. A second AI based topology that is configured to include at least a first of the plurality of personal topology elements to service an overall AI generation objective.

In another artificial intelligence infrastructure, a first AI based topology configured to generate from a person's personal data a personal topology element. Also, a plurality of second AI based topologies each being configured include the personal topology element. The plurality of second AI based topologies each being associated with a compensation requirement for the inclusion.

Further aspects may be found in a first user device with first circuitry having an initial configuration duty defined by a first artificial intelligence based topology partition. The first circuitry gathering personal data from a second artificial intelligence based topology partition of a second user device for use in carrying out the initial configuration.

In a user device with first circuitry, yet other aspects of the present invention may be found. The first circuitry is configured to carry out operations of an artificial intelligence based topology. And the first circuitry selecting at least one node of the artificial intelligence based topology from a plurality of personalized nodes associated with various third parties.

A host service, in a further configuration of the artificial intelligence infrastructure, uses a creator interface configured to support topology creation to address overall artificial intelligence generation objectives. A first hosting interface is also provided to offer download of a plurality of created topologies. A second hosting interface offers downloading of generated output created using the plurality of created topologies.

In accordance with various other aspects of the present invention, a host service supporting an artificial intelligence infrastructure includes a creator interface and a first hosting interface. The creator interface is configured to support creation of a plurality of topology partitions to address an overall artificial intelligence generation objective, while the first hosting interface configured to offer download of a client partition of the plurality of topology partitions.

In addition, although throughout this specification selected exemplary embodiments have been used to illustrate particular aspects of the present invention, all of these aspects are contemplated as being combinable into a single embodiment or extracted into any subset of such aspects into enumerable other embodiments. Thus, the boundaries of each embodiment regarding particular aspects included therein are merely for illustrating operation of a select group of aspects and are in no way considered to limit the overall breadth of such aspects or the ability of combining them as so desired and as one of ordinary skill in the art can surely contemplate after receiving the teachings herein.

The terms “circuit” and “circuitry” as used herein may refer to an independent circuit or to a portion of a multifunctional circuit that performs multiple underlying functions. For example, depending on the embodiment, processing circuitry may be implemented as a single chip processor or as a plurality of processing chips. It may also include neural network circuit elements, accelerators supporting software AI models. Likewise, a first circuit and a second circuit may be combined in one embodiment into a single circuit or, in another embodiment, operate independently perhaps in separate chips. The term “chip,” as used herein, refers to an integrated circuit. Circuits and circuitry may comprise general or specific purpose hardware, or may comprise such hardware and associated software such as firmware or object code.

As one of ordinary skill in the art will appreciate, the terms “operably coupled” and “communicatively coupled,” as may be used herein, include direct coupling and indirect coupling via another component, element, circuit, or module where, for indirect coupling, the intervening component, element, circuit, or module may or may not modify the information of a signal and may adjust its current level, voltage level, and/or power level. As one of ordinary skill in the art will also appreciate, inferred coupling (i.e., where one element is coupled to another element by inference) includes direct and indirect coupling between two elements in the same manner as “operably coupled” and “communicatively coupled.”

The present invention has also been described above with the aid of method steps illustrating the performance of specified functions and relationships thereof. The boundaries and sequence of these functional building blocks and method steps have been arbitrarily defined herein for convenience of description, and can be apportioned and ordered in different ways in other embodiments within the scope of the teachings herein. Alternate boundaries and sequences can be defined so long as certain specified functions and relationships are appropriately performed/present. Any such alternate boundaries or sequences are thus within the scope and spirit of the claimed invention.

The present invention has been described above with the aid of functional building blocks illustrating the performance of certain significant functions. The boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block/step boundaries and sequence could have been defined otherwise and still perform the certain significant functionality. Such alternate definitions of both functional building blocks and flow diagram blocks and sequences are thus within the scope and spirit of the claimed invention.

One of average skill in the art will also recognize that the functional building blocks, and other illustrative blocks, modules and components herein, can be implemented as illustrated or by discrete components, application specific integrated circuits, processors executing appropriate software and the like or any combination thereof. Although the Internet is taught herein, the Internet may be configured in one of many different manners, may contain many different types of equipment in different configurations, and may be replaced or augmented with any network or communication protocol of any kind.

Moreover, although described in detail for purposes of clarity and understanding by way of the aforementioned embodiments, the present invention is not limited to such embodiments. It will be obvious to one of average skill in the art that various changes and modifications may be practiced within the spirit and scope of the invention, as limited only by the scope of the appended claims.

What is claimed is:

1-20. (canceled)

21. An artificial intelligence infrastructure, comprising:
host circuitry configured to provide a first service based on a first topology;
user circuitry configured to provide a second service based on a second topology;
third party circuitry to provide a third service based on a third topology;
at least one artificial intelligence node participating within at least one of the first topology, the second topology and the third topology; and
the first topology, the second topology and the third topology together servicing an overall artificial intelligence based objective.

22. The artificial intelligence infrastructure of claim 21, wherein:
the host circuitry is operable to allow topology creator preferences for node operations.

23. The artificial intelligence infrastructure of claim 21, wherein:
the host circuitry is operable to tailor training sessions based on user feedback.

24. The artificial intelligence infrastructure of claim 21, wherein:
the host circuitry is operable to allow recipients to personalize shared content.

25. The artificial intelligence infrastructure of claim 21, wherein:
the host circuitry is operable to utilize tools for extracting subsets of pre-certified training sets.

26. An artificial intelligence infrastructure, comprising:
an interface through which population readied output of an artificial intelligence node is configured to be received;
client memory circuitry configured to store population data; and
client circuitry configured to populate the population readied output based on the population data.

27. The artificial intelligence infrastructure of claim 26, wherein:
the client circuitry is operable to allow topology creator preferences for node operations.

28. The artificial intelligence infrastructure of claim 26, wherein:
the client circuitry is operable to tailor training sessions based on user feedback.

29. The artificial intelligence infrastructure of claim 26, wherein:
the client circuitry is operable to allow recipients to personalize shared content.

30. The artificial intelligence infrastructure of claim 26, wherein:
the client circuitry is operable to utilize tools for extracting subsets of pre-certified training sets.

31. An artificial intelligence training infrastructure, comprising:
processing circuitry configured to retrieve a first training dataset and a second training dataset; and
the processing circuitry configured to at least partially train a first artificial intelligence node independently and at least partially train a topology that includes the first artificial intelligence node.

32. The artificial intelligence training infrastructure of claim 31, wherein:
the processing circuitry is operable to allow topology creator preferences for node operations.

33. The artificial intelligence training infrastructure of claim 31, wherein:
the processing circuitry is operable to tailor training sessions based on user feedback.

34. The artificial intelligence training infrastructure of claim 31, wherein:
the processing circuitry is operable to allow recipients to personalize shared content.

35. The artificial intelligence training infrastructure of claim 31, wherein:
the processing circuitry is operable to utilize tools for extracting subsets of pre-certified training sets.

36. An artificial intelligence infrastructure, comprising:
processing circuitry configured to support a step-wise creation of a multi-node artificial intelligence generative topology using various data; and
the processing circuitry configured to identify digital rights associated with the various data and convey the identified digital rights across the multi-node artificial intelligence generative topology as the multi-node artificial intelligence generative topology is created.

37. The artificial intelligence infrastructure of claim 36, wherein:
the processing circuitry is operable to allow topology creator preferences for node operations.

38. The artificial intelligence infrastructure of claim 36, wherein:
the processing circuitry is operable to tailor training sessions based on user feedback.

39. The artificial intelligence infrastructure of claim 36, wherein:
the processing circuitry is operable to allow recipients to personalize shared content.

40. The artificial intelligence infrastructure of claim 36, wherein:
the processing circuitry is operable to utilize tools for extracting subsets of pre-certified training sets.
